(19) United States
(12) Patent Application Publication
(10) Pub. No.: US 2025/0266615 A1
(43) Pub. Date: Aug. 21, 2025

(54) ANTENNA DEVICE AND COMMUNICATION DEVICE

(71) Applicant: KABUSHIKI KAISHA TOSHIBA, Tokyo (JP)

(72) Inventors: Kentaro WADA, Kawasaki Kanagawa (JP); Koh HASHIMOTO, Yokohama Kanagawa (JP)

(73) Assignee: KABUSHIKI KAISHA TOSHIBA, Tokyo (JP)

(21) Appl. No.: 19/013,383

(22) Filed: Jan. 8, 2025

(30) Foreign Application Priority Data
Feb. 16, 2024 (JP) 2024-022295

(51) Int. Cl. H01Q 3/38; H01Q 21/06

(52) U.S. Cl. CPC H01Q 3/38; H01Q 21/06

(57) ABSTRACT

According to one embodiment, an antenna device includes a plurality of left phase shifters, a plurality of right phase shifters, and a plurality of antennas. The left phase shifters include a first left phase shifter and a second left phase shifter. The first left phase shifter is configured to discretely control a first left phase of a first left-handed circularly polarized signal. The second left phase shifter is configured to discretely control a first left phase of a second left-handed circularly polarized signal. The right phase shifters include a first right phase shifter and a second right phase shifter. The first right phase shifter is configured to discretely control a first right phase of a first right-handed circularly polarized signal. The second right phase shifter is configured to discretely control a second right phase of a second right-handed circularly polarized signal.

### CROSS-REFERENCE TO RELATED APPLICATIONS

This application is based upon and claims the benefit of priority from Japanese Patent Application No. 2024-022295, filed on Feb. 16, 2024; the entire contents of which are incorporated herein by reference.

### FIELD

Embodiments described herein relate generally to an antenna device and a communication device.

### BACKGROUND

For example, antenna devices are used in communication devices and the like. It is desired to improve the characteristics of antenna devices.

### BRIEF DESCRIPTION OF THE DRAWINGS

FIG. 1 is a schematic diagram illustrating an antenna device according to the first embodiment;

FIGS. 2 and 3 are schematic diagrams illustrating a part of the antenna device according to the first embodiment;

FIG. 4 is a schematic diagram illustrating the antenna device according to the first embodiment;

FIG. 5 is a schematic diagram illustrating the antenna device according to the first embodiment;

FIGS. 6A to 6C are schematic diagrams illustrating the antenna device according to the first embodiment;

FIG. 7 is a schematic diagram illustrating the antenna device according to the first embodiment;

FIG. 8 is a graph illustrating the characteristics of the antenna device according to the first embodiment;

FIGS. 9A and 9B are schematic diagrams illustrating the antenna device according to the first embodiment;

FIG. 10 is a schematic diagram illustrating an antenna device according to a second embodiment;

FIGS. 11A and 11B are graphs illustrating the characteristics of the antenna device;

FIG. 12 is a schematic diagram illustrating the antenna device according to the second embodiment;

FIGS. 13A and 13B are graphs illustrating the characteristics of the antenna device according to the second embodiment;

14A and 14B are schematic diagrams illustrating the antenna device according to a second embodiment;

15A and 15B are schematic diagrams illustrating the antenna device according to a second embodiment;

FIGS. 16A and 16B are schematic diagrams illustrating an antenna device according to the second embodiment;

FIG. 17 is a graph illustrating the characteristics of the antenna device according to the second embodiment;

FIG. 18 is a schematic diagram illustrating an antenna device according to the second embodiment; and

FIGS. 19A and 19B are graphs illustrating the characteristics of the antenna device according to the second embodiment.

### DETAILED DESCRIPTION

According to one embodiment, an antenna device includes a plurality of left phase shifters, a plurality of right phase shifters, and a plurality of antennas. The plurality of left phase shifters include a first left phase shifter and a second left phase shifter. The first left phase shifter is configured to discretely control a first left phase of a first left-handed circularly polarized signal. The second left phase shifter is configured to discretely control a first left phase of a second left-handed circularly polarized signal. The plurality of right phase shifters include a first right phase shifter and a second right phase shifter. The first right phase shifter is configured to discretely control a first right phase of a first right-handed circularly polarized signal. The second right phase shifter is configured to discretely control a second right phase of a second right-handed circularly polarized signal. The plurality of antennas include a first antenna and a second antenna. The first left phase shifter is configured to supply the first left-handed circularly polarized signal to the first antenna. The first right-handed phase shifter is configured to supply the first right-handed circularly polarized signal to the first antenna. The first antenna is configured to transmit a first left-handed circularly polarized wave based on the first left-handed circularly polarized signal and a first right-handed circularly polarized wave based on the first right-handed circularly polarized signal. The second left-handed phase shifter is configured to supply the second left-handed circularly polarized signal to the second antenna. The second right-handed phase shifter is configured to supply the second right-handed circularly polarized signal to the second antenna. The second antenna is configured to transmit a second left-handed circularly polarized wave based on the second left-handed circularly polarized signal and a second right-handed circularly polarized wave based on the second right-handed circularly polarized signal. A first polarization angle of a first linearly polarized wave generated by the first left-handed circularly polarized wave and the first right-handed circularly polarized wave is different from a second polarization angle of a second linearly polarized wave generated by the second left-handed circularly polarized wave and the second right-handed circularly polarized wave.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

In the following description, the x-axis, y-axis, and z-axis represent mutually orthogonal axes.

### First Embodiment

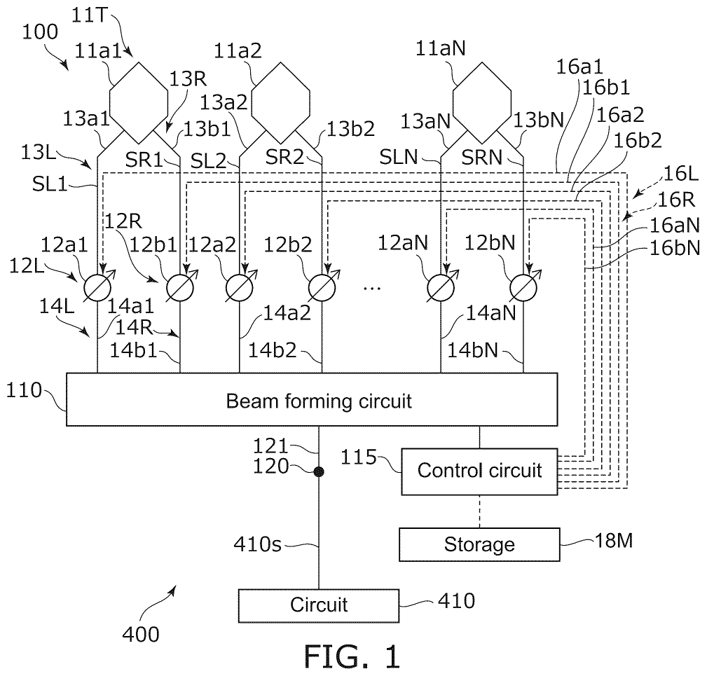

FIG. 1 is a schematic diagram illustrating an antenna device according to the first embodiment.

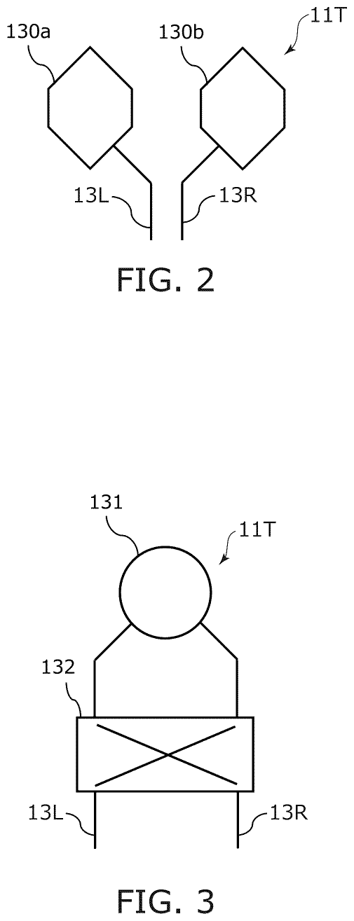

FIGS. 2 and 3 are schematic diagrams illustrating a part of the antenna device according to the first embodiment.

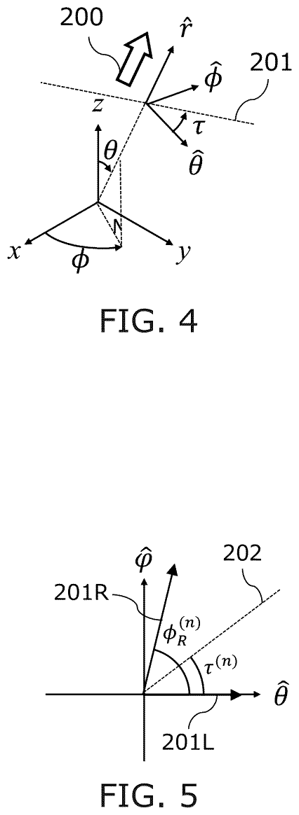

FIG. 4 is a schematic diagram illustrating the antenna device according to the first embodiment.

FIG. 5 is a schematic diagram illustrating the antenna device according to the first embodiment.

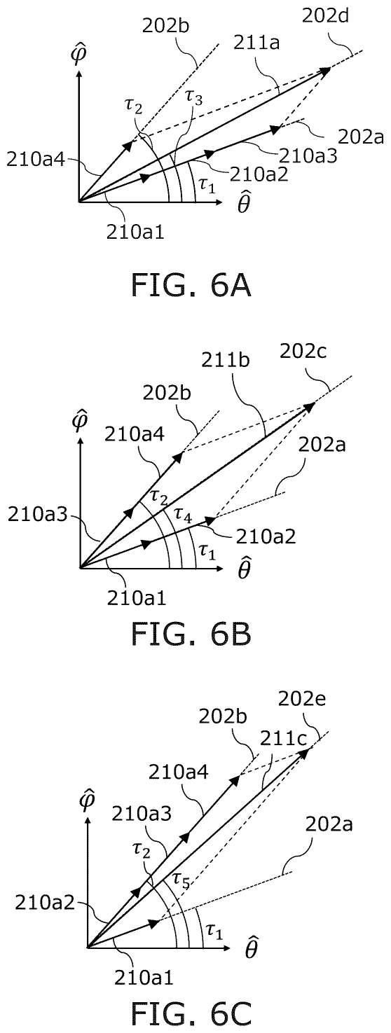

FIGS. 6A to 6C are schematic diagrams illustrating the antenna device according to the first embodiment.

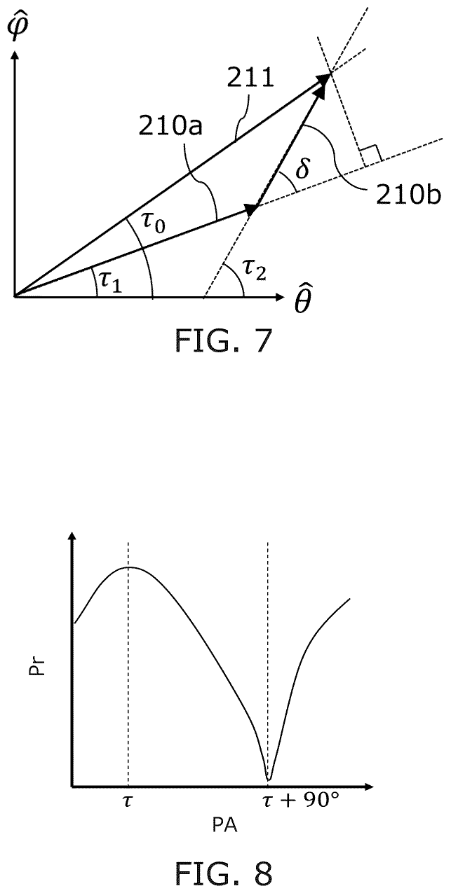

FIG. 7 is a schematic diagram illustrating the antenna device according to the first embodiment.

An antenna device 100 according to the embodiment is capable of transmitting left-handed circularly polarized waves and right-handed circularly polarized waves. Alternatively, the antenna device 100 according to the embodiment can receive left-handed circularly polarized waves and right-handed circularly polarized waves.

A high frequency signal representing left-handed circularly polarized waves is defined as a left-handed circularly polarized signal. A high frequency signal representing right-handed circularly polarized waves is defined as a right-handed circularly polarized signal. The antenna device 100 is configured to control the amplitude of the left-handed circularly polarized signal and the phase of the left-handed circularly polarized signal. The antenna device 100 is configured to control the amplitude of the right-handed circularly polarized signal and the phase of the right-handed circularly polarized signal.

For example, the antenna device 100 can transmit linearly polarized waves by simultaneously transmitting left-handed circularly polarized waves and right-handed circularly polarized waves. For example, the antenna device 100 can receive linearly polarized waves by simultaneously receiving left-handed circularly polarized waves and right-handed circularly polarized waves.

The antenna device 100 includes a phase shifter. The phase shifter controls the phase of the left-handed circularly polarized signal and the right-handed circularly polarized signal. The antenna device 100 includes, for example, a signal processing circuit 110. The signal processing circuit 110 is, for example, a beamforming circuit. The signal processing circuit 110 controls the amplitude of the left-handed circularly polarized signal and the amplitude of the right-handed circularly polarized signal. By controlling the phase shift amount of the phase shifter, the antenna device 100 controls the polarization angle of the linearly polarized waves to be transmitted. By controlling the phase shift amount of the phase shifter, the antenna device 100 controls the polarization angle of the received linearly polarized waves. When antenna device 100 is a receiving antenna device, signal processing circuit 110 is, for example, a power combiner.

In the embodiment, “transmitting/receiving” corresponds to “at least one of transmitting or receiving”. In the embodiment, “transmitted/received” corresponds to “at least one of transmitted or received”. In the embodiment, “transmit/receive” corresponds to “at least one of transmit or receive”.

FIG. 4 illustrates the polarization plane and polarization angle T of radio waves transmitted/received by the antenna device 100. “r hat” represents a symbol obtained by attaching a hat symbol to r. “θ hat” represents a symbol obtained by attaching a hat symbol to θ. “ϕ hat” represents a symbol obtained by attaching a hat symbol to ϕ.

The r-hat axis, the θ-hat axis, and the ϕ-hat axis are orthogonal to each other. On the r-hat axis, the direction away from the origin shown in FIG. 4 is defined as positive. The r-hat axis coincides with the beam direction 200 of the antenna device 100. The beam direction is represented by θ and ϕ. θ is an angle. ϕ is an angle.

When the antenna device 100 transmits radio waves, the beam direction corresponds to the transmission direction of the radio waves. When the antenna device 100 receives radio waves, the beam direction corresponds to the direction in which the radio waves are received.

The polarization plane represents the vibration direction of a linearly polarized electric field transmitted/received by one of the plurality of antennas 11T (see FIG. 1) included in the antenna device 100. In elliptically polarized waves, the plane of polarization is defined as a long axis direction of the elliptically polarized waves. In embodiments, linearly polarized waves include elliptically polarized waves. The polarization angle corresponds to the angle between the polarization plane of the linearly polarized waves and the θ hat axis. In FIG. 4, the polarization angle is represented by T.

The antenna device 100 complies with, for example, a wireless communication standard or a wireless LAN (Local Area Network) standard. The wireless communication standards include, for example, the fifth generation mobile communication system (so-called 5G) or Bluetooth (registered trademark). The wireless LAN includes, for example, IEEE802.11ax.

The antenna device 100 may be complies with radar or wireless power feeding technology. The radar uses a frequency band such as a 9 GHz band, a 24 GHz band, or a 76 GHz band. Microwaves and the like are used in wireless power feeding technology.

The antenna device 100 may be configured to transmit/receive radio waves in the UHF band, SHF band, or EHF band, for example. In the UHF (Ultra-High Frequency) band, the frequency is not less than 300 MHz and not more than 3 GHZ. In the SHF (Super High Frequency) band, the frequency is not less than 3 GHZ and not more than 30 GHz. In the EHF (Extremely High Frequency) band, the frequency is not less than 30 GHz and not more than 300 GHz.

As shown in FIG. 1, the antenna device 100 includes, for example, a plurality of antennas 11T, a plurality of left phase shifters 12L, and a plurality of right phase shifters 12R. The number of plurality of antennas 11T is “N”. “N” is an integer of 2 or more. The number of left phase shifters 12L may be “N”. The number of the plurality of right phase shifters 12R may be “N”.

The plurality of antennas 11T include, for example, a first antenna 11a1, a second antenna 11a2, and an n-th antenna 11aN. The plurality of left phase shifters 12L include, for example, a first left phase shifter 12a1, a second left phase shifter 12a2, an N-th left phase shifter 12aN, and the like. The plurality of right phase shifters 12R include, for example, a first right phase shifter 12b1, a second right phase shifter 12b2, an N-th right phase shifter 12bN, and the like.

The antenna device 100 may further include, for example, a plurality of left transmission lines 13L and a plurality of right transmission lines 13R. The number of left transmission lines 13L may be “N”. The number of the plurality of right transmission lines 13R is “N”. The plurality of left transmission lines 13L include, for example, a first left transmission line 13a1, a second left transmission line 13a2, an N-th left transmission line 13aN, and the like. The plurality of right transmission lines 13R include, for example, a first right transmission line 13b1, a second right transmission line 13b2, an N-th right transmission line 13bN, and the like.

For example, one of the plurality of left phase shifters 12L and one of the plurality of right phase shifters 12R are coupled to one of the plurality of antennas 11T.

The n-th left phase shifter 12an is coupled to the n-th antenna 11an via the n-th left transmission line 13an. The n-th right phase shifter 12bn is coupled to the n-th antenna 11an via the n-th right transmission line 13bn. “n” is an integer not less than 1 and not more than “N”.

The plurality of left phase shifters 12L and the plurality of right phase shifters 12R are coupled to the signal processing circuit 110. The antenna device 100 includes, for example, a plurality of left lines 14L and a plurality of right lines 14R. The number of left phase shifters 12L is “N”. The number of right phase shifters 12R is “N”. The plurality of left lines 14L include, for example, a first left line 14a1, a second left line 14a2, an N-th left line 14aN, and the like. The plurality of right lines 14R include, for example, a first right line 14b1, a second right line 14b2, an N-th right line 14bN, and the like.

For example, the n-th left phase shifter 12an is coupled to the signal processing circuit 110 by the n-th left line 14an. The n-th right phase shifter 12bn is coupled to the signal processing circuit 110 via the n-th right line 14bn.

The antenna device 100 may include, for example, a control circuit 115, a plurality of left signal lines 16L, and a plurality of right signal lines 16R. The control circuit 115 is coupled to signal processing circuit 110. One of the plurality of left phase shifters 12L is coupled to the control circuit 115 by one of the plurality of left signal lines 16L. One of the plurality of right phase shifters 12R is coupled to the control circuit 115 by one of the plurality of right signal lines 16R.

The plurality of left signal lines 16L include, for example, a first left signal line 16a1, a second left signal line 16a2, an N-th left signal line 16aN, and the like. The plurality of right signal lines 16R include, for example, a first right signal line 16b1, a second right signal line 16b2, and an N-th right signal line 16bN. For example, the n-th left phase shifter 12an is coupled to the control circuit 115 via the n-th left signal line 16an. For example, the n-th right phase shifter 12bn is coupled to the control circuit 115 via the n-th right signal line 16bn.

The antenna device 100 includes, for example, a feeding point 120 and a transmission line 121. The signal processing circuit 110 is coupled to the feeding point 120 by the transmission line 121.

The antenna device 100 controls the phases of left-handed circularly polarized waves and right-handed circularly polarized waves transmitted/received by the plurality of antennas 11T. Thereby, the antenna device 100 can control the beam directions of left-handed circularly polarized waves and right-handed circularly polarized waves.

One of the plurality of left phase shifters 12L is capable of controlling the phase of a left-handed circularly polarized signal indicating left-handed circularly polarized wave transmitted/received by one of the plurality of antennas 11T. One of the plurality of right phase shifters 12R can control the phase of a right-handed circularly polarized signal indicating right-handed circularly polarized wave transmitted/received by one of the plurality of antennas 11T.

In the embodiment, the phase of the left-handed circularly polarized waves is the same as the phase of the left-handed circularly polarized signal. In the embodiment, the phase of the right-handed circularly polarized waves is the same as the phase of the right-handed circularly polarized signal.

For the plurality of antennas 11T, any antenna capable of transmitting/receiving right-handed circularly polarized waves and left-handed circularly polarized waves can be applied. In FIG. 1, the plurality of antennas 11T are patch antennas using elements that can degenerate orthogonal modes. FIGS. 2 and 3 show an example different from the example of FIG. 1.

For example, in the example shown in FIG. 2, one of the plurality of antennas 11T includes a left radiating element 130a and a right radiating element 130b. The left radiating element 130a is capable of transmitting/receiving left-handed circularly polarized waves. The right radiating element 130b is capable of transmitting/receiving right-handed circularly polarized waves.

For example, in the example shown in FIG. 3, one of the plurality of antennas 11T includes a radiating element 131 and an external circuit 132. The radiating element 131 is capable of transmitting/receiving orthogonal linearly polarized waves. The external circuit 132 is connected to radiating element 131. The external circuit 132 is, for example, a 90-degree hybrid circuit. The external circuit 132 can generate, for example, a right-handed circularly polarized signal and a left-handed circularly polarized signal from a high frequency signal indicating linearly polarized waves input to the external circuit 132. Hereinafter, the high frequency signal indicating linearly polarized waves input to the external circuit 132 will be referred to as a “linearly polarized signal”. For example, the external circuit 132 can generate a linearly polarized signal from the right-handed circularly polarized signal and the left-handed circularly polarized signal input to the external circuit 132. By providing the external circuit 132, the radiating element 131 can transmit/receive right-handed circularly polarized waves and left-handed circularly polarized waves.

For example, any configuration capable of transmitting/receiving right-handed circularly polarized waves and left-handed circularly polarized waves is applied to the plurality of antennas 11T. At least one selected from the group consisting of a patch antenna, a dipole antenna, a helical antenna, a slot antenna, and a lens antenna can be applied to the plurality of antennas 11T. An antenna using a metamaterial or the like may be applied to the plurality of antennas 11T. The plurality of antennas 11T may include antennas that are a combination of different types of antennas.

The plurality of left phase shifters 12L and the plurality of right phase shifters 12R are, for example, digital phase shifters whose phase shift amount can be switched discretely. The plurality of left phase shifters 12L and the plurality of right phase shifters 12R may include, for example, MEMS phase shifters. In the MEMS phase shifter, the line length can be changed by a MEMS switch. The plurality of left phase shifters 12L and the plurality of right phase shifters 12R may include, for example, reflective phase shifters. The reflective phase shifter includes, for example, a variable impedance element such as a variable capacitance diode, a transmission line whose line length can be switched, and a 90-degree hybrid circuit. The plurality of left phase shifters 12L and the plurality of right phase shifters 12R may include, for example, digital phase shifters. In the digital phase shifter, a plurality of different types of digital phase shifters may be combined. For example, any digital phase shifter that can discretely switch the phase shift amount may be applied to the plurality of left phase shifters 12L and the plurality of right phase shifters 12R.

The digital phase shifter can be made smaller and has a shorter phase switching time than an analog phase shifter that can continuously vary the phase shift amount. On the other hand, in the digital phase shifter, the phase shift amount is limited to a discrete value. The phase shift amount of the digital phase shifter is generally expressed using the number of bits Nb. The phase shift amount of the Nb bit phase shifter is substantially an integer multiple of 360°/(2\hat{ }Nb). For example, in a 4-bit phase shifter, the phase shift amount is a substantially integer multiple of 360°/(2\hat{ }4)=22.5°. In a 6-bit phase shifter, the phase shift amount is substantially an integer multiple of 360°/(2\hat{ }6)=5.625°.

In the digital phase shifter, if the number of bits Nb is large, the phase shift amount can be finely controlled. Generally, as the number of bits Nb of the phase shifter increases, the configuration of the phase shifter becomes more complex. As the number of bits Nb increases, for example, the price of the phase shifter increases.

The plurality of left phase shifters 12L and the plurality of right phase shifters 12R may include, for example, a plurality of digital phase shifters having all the same number of bits. The plurality of left phase shifters 12L and the plurality of right phase shifters 12R may include digital phase shifters having a different number of bits. For example, the number of bits in one of the plurality of left phase shifters 12L may be different from the number of bits in another one of the plurality of left phase shifters 12L. For example, the number of bits in one of the plurality of right phase shifters 12R may be different from the number of bits in another one of the plurality of right phase shifters 12R.

The plurality of left transmission lines 13L, the plurality of right transmission lines 13R, the plurality of left lines 14L, the plurality of right lines 14R, and the transmission line 121 are capable of transmitting high frequency signals. At least one of these lines may include, for example, at least one selected from the group consisting of a microstrip line, a coplanar line, a waveguide, and a coaxial cable. At least one of these lines may transmit a high frequency signal in a non-contact manner, for example, by electromagnetic coupling. At least one of these lines may transmit a high frequency signal in a non-contact manner, for example, by transmitting/receiving radio waves.

The plurality of left signal lines 16L and the plurality of right signal lines 16R may include, for example, at least one selected from the group consisting of electric wires, microstrip lines, coplanar lines, waveguides, and coaxial cables. The plurality of left signal lines 16L and the plurality of right signal lines 16R may transmit signals in a non-contact manner by electromagnetic coupling. The plurality of left signal lines 16L and the plurality of right signal lines 16R may transmit signals in a non-contact manner by transmitting/receiving radio waves. Any configuration capable of transmitting electrical signals may be applied to the plurality of left signal lines 16L and the plurality of right signal lines 16R.

The electrical signals transmitted by the plurality of left signal lines 16L and the plurality of right signal lines 16R may include at least one selected from the group consisting of a high frequency signal, a DC signal, and a low frequency signal.

A signal is input from the feeding point 120 to the signal processing circuit 110 via the transmission line 121. For example, when the antenna device 100 transmits radio waves, the signal processing circuit 110 controls the amplitude of the signal input to the signal processing circuit 110 and distributes the signal to the plurality of left phase shifters 12L and the plurality of right phase shifters 12R. By using the signal processing circuit 110, the amplitudes of left-handed circularly polarized waves and right-handed circularly polarized waves transmitted by the plurality of antennas 11T can be controlled.

The signal processing circuit 110 is configured to distribute the signals so that the amplitude of the left-handed circularly polarized signal supplied to the n-th left phase shifter 12an and the amplitude of the right-handed circularly polarized signal supplied to the n-th right phase shifter 12bn are substantially equal to each other, for example.

The amplitude of the left-handed circularly polarized signal that the signal processing circuit 110 outputs to the n-th left phase shifter 12an may be different from the amplitude of the left-handed circularly polarized signal that the signal processing circuit 110 outputs to the m-th left phase shifter 12 am. “m” is an integer not less than 1 and not more than “N”, and is different from “n”.

The amplitude of the right-handed circularly polarized signal that the signal processing circuit 110 outputs to the n-th right phase shifter 12bn may be different from the amplitude of the right-handed circularly polarized signal that the signal processing circuit 110 outputs to the m-th right phase shifter 12bm.

For example, when the antenna device 100 receives radio waves, the signal processing circuit 110 controls and combines the amplitudes of the left-handed circularly polarized signal and the right-handed circularly polarized signal output from the plurality of antennas 11T. The signal processing circuit 110 outputs the combined signal to feeding point 120 via the transmission line 121. By using the signal processing circuit 110, the antenna device 100 can change and synthesize left-handed circularly polarized waves and right-handed circularly polarized waves received by the plurality of antennas 11T.

The signal processing circuit 110 can be provided with any configuration capable of distributing high frequency signals or synthesizing high frequency signals. The signal processing circuit 110 may include, for example, at least one of an analog circuit or a digital circuit.

The control circuit 115 may include, for example, at least one of a central processing unit (CPU), a digital signal processor (DSP), a microcomputer, or an FPGA (Field Programmable Gate Array).

The control circuit 115 controls, for example, the plurality of left phase shifters 12L, the plurality of right phase shifters 12R, and the signal processing circuit 110. The control circuit 115 transmits/receives control signals via the plurality of left signal lines 16L to control the plurality of left phase shifters 12L. The control circuit 115 transmits/receives control signals via the plurality of right signal lines 16R to control the plurality of right phase shifters 12R.

For example, when the antenna device 100 transmits radio waves, the control circuit 115 controls the phase shift amount of the plurality of left phase shifters 12L, the phase shift amount of the plurality of right phase shifters 12R, the amplitude of the right-handed circularly polarized signal output by the signal processing circuit 110, and the amplitude of the left-handed circularly polarized signal output by the signal processing circuit 110.

The control circuit 115 controls, for example, the amplitude of the left-handed circularly polarized signal that the signal processing circuit 110 outputs to the plurality of left lines 14L. The control circuit 115 controls, for example, the amplitude of the right-handed circularly polarized signal that the signal processing circuit 110 outputs to the plurality of right lines 14R. When a left-handed circularly polarized waves are input, the plurality of antennas 11T transmit the left-handed circularly polarized waves. When a right-handed circularly polarized signal is input, the plurality of antennas 11T transmit the right-handed circularly polarized waves.

The plurality of antennas 11T transmit linearly polarized waves when a left-handed circularly polarized signal and a right-handed circularly polarized signal are input. The amplitude of the left-handed circularly polarized signal is substantially the same as the amplitude of this right-handed circularly polarized signal. The frequency band of the left-handed circularly polarized signal is substantially the same as the frequency band of this right-handed circularly polarized signal.

The control circuit 115 controls the phase shift amount of the plurality of left phase shifters 12L and the phase shift amount of the plurality of right phase shifters 12R. Thereby, the control circuit 115 controls the polarization angle and beam direction of the linearly polarized waves transmitted by the antenna device 100.

When the antenna device 100 receives radio waves, the control circuit 115 controls the phase shift amount of the plurality of left phase shifters 12L, the phase shift amount of the plurality of right phase shifters 12R, the amplitude of the left-handed circularly polarized signal input to the signal processing circuit 110, and the amplitude of the right-handed circularly polarized signal input to the signal processing circuit 110. The control circuit 115 controls the phase shift amount of the left-handed circularly polarized signal corresponding to the left-handed circularly polarized waves input from the plurality of antennas 11T to the plurality of left phase shifters 12L by controlling the phase shift amount. The control circuit 115 controls the phase shift amount of the right-handed circularly polarized signal corresponding to the right-handed circularly polarized waves input from the plurality of antennas 11T to the plurality of right phase shifters 12R by controlling the phase shift amount.

The control circuit 115 controls the amplitude of the left-handed circularly polarized signal input to the signal processing circuit 110 from the plurality of left lines 14L. The control circuit 115 controls the amplitude of the right-handed circularly polarized signal input to the signal processing circuit 110 from the plurality of right lines 14R. When the plurality of antennas 11T receive left-handed circularly polarized waves, the left-handed circularly polarized signal is output. When the plurality of antennas 11T receive the right-handed circularly polarized waves, the right-handed circularly polarized signal is output. When the plurality of antennas 11T receive linearly polarized waves, a left-handed circularly polarized signal and a right-handed circularly polarized signal are output. The frequency band of this left-handed circularly polarized signal is substantially equal to the frequency band of this right-handed circularly polarized signal.

The control circuit 115 controls the phase shift amount of the plurality of left phase shifters 12L and the phase shift amount of the plurality of right phase shifters 12R. Thereby, the control circuit 115 can control the polarization angle and beam direction of the linearly polarized waves that the antenna device 100 receives.

The control circuit 115 can control the linearly polarized signal output by the signal processing circuit 110 by controlling the plurality of left phase shifters 12L, the plurality of right phase shifters 12R, and the signal processing circuit 110.

The control circuit 115 may be couplable to the storage 18M (see FIG. 1). The storage 18M can store various types of information related to the embodiment. The various types of information include, for example, information regarding the phase shift amount, the amplitude of the left-handed circularly polarized signal, the phase of the left-handed circularly polarized signal, the amplitude of the right-handed circularly polarized signal, and the phase of the right-handed circularly polarized signal.

The storage 18M may include, for example, at least one of a random access memory (RAM), a flash memory, or a hard disk drive (HDD). The antenna device 100 may include the storage 18M. The storage 18M may be provided separately from the antenna device 100.

Hereinafter, an example of polarization angle control in the embodiment will be described.

FIG. 5 illustrates controlling the polarization angle of linearly polarized waves transmitted/received by one of the plurality of antennas 11T. FIG. 5 illustrates the polarization angle in the beam direction of the antenna device 100. The phase of left-handed circularly polarized waves transmitted/received by the n-th antenna 11an is assumed to be an angle ϕ_{L}⁽ⁿ⁾. The phase of right-handed circularly polarized waves transmitted/received by the n-th antenna 11an is assumed to be an angle ϕ_{R}⁽ⁿ⁾.

In FIG. 5, the left-handed circularly polarized waves transmitted/received by the n-th antenna 11an is represented by a left vector 201L. The left-handed circularly polarized waves transmitted/received by the n-th antenna 11an is represented by a right vector 201R. The angle between the left vector 201L and the θ hat axis corresponds to the angle ϕ_{L}⁽ⁿ⁾. The angle between the right vector 201R and the θ hat axis corresponds to the angle ϕ_{R}⁽ⁿ⁾.

The length of the left vector 201L corresponds to the amplitude of left-handed circularly polarized waves transmitted/received by the n-th antenna 11an. The length of the right vector 201R corresponds to the amplitude of the right-handed circularly polarized waves transmitted/received by the n-th antenna 11an. In FIG. 5, the length of left vector 201L is substantially equal to the length of right vector 201R.

The difference Δψ⁽ⁿ⁾ between the angle ϕ_{L}⁽ⁿ⁾ and the angle ϕ_{R}⁽ⁿ⁾ is defined by formula (1).

$$Δ {ψ}^{( n )} = {ϕ}_{R}^{( n )} - {ϕ}_{L}^{( n )} \qquad ( 1 )$$

The polarization angle τ⁽ⁿ⁾ of the linearly polarized waves transmitted/received by the n-th antenna 11an is expressed by formula (2) using the difference Δψ⁽ⁿ⁾. In FIG. 5, the angle ϕ_{L}⁽ⁿ⁾ is 0°.

$${τ}^{( n )} = Δ {ψ}^{( n )} / 2 \qquad ( 2 )$$

When the angle ϕ_{L}⁽ⁿ⁾ is equal to the angle ϕ_{R}⁽ⁿ⁾, the polarization angle τ⁽ⁿ⁾ of the linearly polarized waves transmitted/received by the n-th antenna 11an is 0°. When the difference between the angle ϕ_{L}⁽ⁿ⁾ and the angle ϕ_{R}⁽ⁿ⁾ is 180°, the polarization angle τ⁽ⁿ⁾ of the linearly polarized waves transmitted/received by the n-th antenna 11an is 90°.

The polarization angle of the linearly polarized waves received by the n-th antenna 11an corresponds to τ⁽ⁿ⁾ given by formula (2). The n-th left phase shifter 12an corresponds to the n-th antenna 11an. The n-th right phase shifter 12bn corresponds to the n-th antenna 11an. τ⁽ⁿ⁾ is given by formula (2) from the relative phase shift amount between the left-handed circularly polarized signal output by the n-th left phase shifter 12an and the left-handed circularly polarized signal output by the n-th right phase shifter 12bn.

The polarization angle of the linearly polarized wave arriving at the n-th antenna 11an does not necessarily match τ⁽ⁿ⁾.

The n-th left phase shifter 12an and the n-th right phase shifter 12bn are, for example, digital phase shifters that can discretely switch the phase shift amount. Therefore, the phase shift amount of the n-th left phase shifter 12an and the phase shift amount of the n-th right phase shifter 12bn are limited to substantially an integer multiple of the minimum phase shift amount α. The minimum phase shift amount α is given by formula (3) when the number of bits of the phase shifter is Nb.

$$α = 360 ° / {2}^{N b} \qquad ( 3 )$$

From formula (3), the angle ϕ_{L}⁽ⁿ⁾ and the angle ϕ_{R}⁽ⁿ⁾ are limited to substantially an integer multiple of the minimum phase shift amount α.

From formulas (1) and (3), in the antenna device 100 according to the embodiment, the difference Δψ⁽ⁿ⁾ between the angle ϕ_{L}⁽ⁿ⁾ and the angle ϕ_{R}⁽ⁿ⁾ is substantially an integer multiple of the minimum phase shift amount α.

From formulas (1), (2), and (3), in the antenna device 100 according to the embodiment, τ⁽ⁿ⁾ is limited to be substantially an integer multiple of half (α/2) of the minimum phase shift amount α. Therefore, the polarization angle of the linearly polarized waves transmitted/received by the n-th antenna 11an is limited to substantially an integer multiple of α/2.

In the antenna device 100 according to the embodiment, the polarization angle of linearly polarized waves transmitted/received by each of the plurality of antennas 11T is limited to substantially an integer multiple of α/2. For example, the phase shift amount of the plurality of left phase shifters 12L and the phase shift of the plurality of right phase shifters 12R are controlled so that the polarization angles of linearly polarized waves transmitted/received by each of the plurality of antennas 11T are substantially equal to each other. At this time, an error occurs between the target polarization angle that is transmitted/received by the antenna device 100 and the polarization angle that is actually transmitted/received. This error becomes maximum when the target polarization angle is an intermediate value of a substantial integer multiple of α/2 (i.e., α/4+Aα/2, where “A” is an arbitrary integer). For example, the maximum value of the polarization angle error is α/4.

For example, when the plurality of left phase shifters 12L and the plurality of right phase shifters 12R are 4-bit phase shifters, the minimum phase shift amount becomes 22.5° from formula (3). At this time, the polarization angle of the linearly polarized waves transmitted/received by the antenna device 100 is limited to a substantial integer multiple of 11.25°. The error between the target polarization angle that antenna device 100 transmits/receives and the polarization angle that is actually transmitted/received is 5.625° at most.

If an error occurs between the target polarization angle that the antenna device 100 transmits/receives and the polarization angle that is actually transmitted/received, problems such as deterioration of communication quality will occur, for example.

When performing wireless communication using the antenna device 100, if an error occurs between the target polarization angle that the antenna device 100 transmits/receives and the polarization angle that is actually transmitted/received, for example, the degree of cross-polarization discrimination (XPD: Cross Polarization Discrimination) decreases. For example, a polarization multiplexing technique is known that multiplexing communications using two orthogonal linearly polarized waves. The polarization multiplexing technology is used in wireless communications or radar to improve frequency efficiency. In wireless communication using the polarization multiplexing technology, when a radio wave with a low XPD is transmitted, the radio wave becomes an interference wave for other communications, and communication quality deteriorates. For example, when the antenna device 100 is used as a radar, the detection characteristics of the radar deteriorate due to a decrease in XPD.

The electric field amplitude of the linearly polarized wave parallel to the target polarization angle is defined as E_{Co}. The electric field amplitude of the linearly polarized wave orthogonal to the target polarization angle is defined as E_{X}. XPD is defined by formula (4).

$$X P D = 20 {log}_{10} \vert {E}_{C o} / {E}_{X} \vert [ dB ] \qquad ( 4 )$$

For example, when the n-th left phase shifter 12an and the n-th right phase shifter 12bn are 4-bit phase shifters, the maximum error of the target polarization angle that the antenna device 100 transmits/receives and the polarization angle that is actually transmitted/received is 5.625°. At this time, E_{Co} becomes cos) (5.625°. E_{X} is sin) (5.625°. When calculating by substituting these values into formula (4), the minimum value of XPD is approximately 20 decibels.

For example, Japan's radio equipment regulations stipulate that the XPD of the antenna for a 9.7 GHz band weather radar is 25 decibels or more. For example, Japan's radio equipment regulations stipulate that the XPD of an antenna is 27 decibels or more for small-scale earth stations in the Ku band (not less than 12 GHz and not more than 14 GHZ).

It is assumed that the plurality of left phase shifters 12L and the plurality of right phase shifters 12R are 4-bit phase shifters, and these the phase shifter are controlled that the polarization angles of the linearly polarized waves transmitted/received by the plurality of antennas 11T are all substantially equal. In this case, when the error between the target polarization angle and the polarization angle actually transmitted/received is maximum, the XPD is about 20 decibels. In this case, antenna device 100 does not meet the above criteria and cannot be used for the above purpose.

For example, by increasing the number of bits Nb of the plurality of left phase shifters 12L and the plurality of right phase shifters 12R, it is possible to reduce errors in polarization angles transmitted/received by the antenna device 100 and improve XPD. However, increasing the number of bits Nb of these phase shifters increases the cost of these phase shifters. If the number of bits Nb of these phase shifters is increased, the cost of the antenna device 100 will increase.

According to the embodiment, for example, the polarization angle transmitted/received by the antenna device 100 can be controlled at intervals narrower than a substantial integer multiple of α/2 without increasing the number of bits Nb of these phase shifters. In the embodiment, for example, the polarization angle can be controlled with high precision using a simple configuration. According to the embodiment, it is possible to provide an antenna device with improved characteristics. According to the embodiment, it is possible to inexpensively improve the XPD of radio waves transmitted/received by the antenna device 100.

In the embodiment, the polarization angles of the linearly polarized waves transmitted/received by the plurality of antennas 11T may be different from each other. The polarization angle of the linearly polarized waves transmitted/received by each of the plurality of antennas 11T is one of τ1 and τ2. τ1 is different from τ2.

For example, the phase shift amount of the plurality of left phase shifters 12L and the phase shift amount of the plurality of right phase shifters 12R may be individually controlled. Thereby, the polarization angles of the linearly polarized waves transmitted/received by the plurality of antennas 11T can be individually controlled. At this time, the polarization angle of the linearly polarized waves transmitted/received by the antenna device 100 is a value different from both τ1 and τ2.

FIGS. 6A to 6C illustrate the relationship between the polarization angle of linearly polarized waves transmitted/received by the plurality of antennas 11T and the polarization angle of the linearly polarized waves transmitted by the antenna device 100. In the examples of FIGS. 6A to 6C, the polarization angles of linearly the polarized waves transmitted/received by each of the plurality of antennas 11T are different from each other. In FIGS. 6A to 6C, “N” is 4. The plurality of antennas 11T includes four antennas. The four antennas include a first antenna 11a1, a second antenna 11a2, a third antenna 11a3 (not shown), and a fourth antenna 11a4 (not shown).

In FIGS. 6A to 6C, four vectors (vector 210a1, vector 210a2, vector 210a3, and vector 210a4) represent linearly polarized waves transmitted/received by each of the four antennas. The vector 211a, the vector 211b, and the vector 211c represent linearly polarized waves that are a combination of linearly polarized waves transmitted/received by each of the four antennas.

The angle between the above four vectors and the θ hat axis represents the polarization angle of the linearly polarized waves transmitted/received by each of the four antennas. The length of each of the four vectors represents the amplitude of linearly polarized waves transmitted/received by each of the four antennas. In the example of FIGS. 6A-6C, the lengths of each of the four vectors are substantially equal to each other. In embodiments, the lengths of each of the four vectors may be different from each other.

In FIG. 6A, the polarization angle of the linearly polarized waves transmitted/received by the first antenna 11a1, the second antenna 11a2, and the third antenna 11a3 is τ1. The polarization angle of linearly the polarized wave transmitted/received by the fourth antenna 11a4 is τ2. The angle between the vector 211a and the θ hat axis is τ3.

In FIG. 6B, the polarization angle of the linearly polarized waves transmitted/received by each of the first antenna 11a1 and the second antenna 11a2 is τ1. The polarization angle of the linearly polarized waves transmitted/received by the third antenna 11a3 and the fourth antenna 11a4 is τ2. The angle between vector 211b and the θ hat axis is τ4.

In FIG. 6C, the polarization angle of the linearly polarized waves transmitted/received by the first antenna 11a1 is τ1. The polarization angle of the linearly polarized waves transmitted/received by the second antenna 11a2, the third antenna 11a3, and the fourth antenna 11a4 is τ2. The angle between the vector 211c and the θ hat axis is τ5.

In FIGS. 6A to 6C, the angle between the vector 211a and the θ hat axis, the angle between the vector 211b and the θ hat axis, and the angle between the vector 211c and the θ hat axis correspond to the polarization angle of the linearly polarized waves that is a combination of the linearly polarized waves being transmitted/received by the four antennas. These angles (and their polarization angles) are different from both τ1 and τ2.

In FIGS. 6A to 6C, the polarization angle of the linearly polarized waves transmitted/received by the antenna device 100 corresponds to the polarization angle of the linearly polarized waves that are a combination of the linearly polarized waves transmitted/received by the four antennas. Therefore, in FIGS. 6A to 6C, the polarization angle of the linearly polarized waves transmitted/received by the antenna device 100 is different from both τ1 and τ2.

In the examples of FIGS. 6A to 6C, τ1, τ2, τ3, τ4, and τ5 satisfy the relationship of formula (5).

$${τ}_{1} < {τ}_{3} < {τ}_{4} < {τ}_{5} < {τ}_{2} \qquad ( 5 )$$

In the examples of FIGS. 6A to 6C, when the difference between τ1 and τ2 is α/2, the polarization angle of the linearly polarized waves transmitted/received by the antenna device 100 is controlled at intervals narrower than α/2.

In the embodiment, the polarization angle of linearly polarized waves transmitted/received by the antenna device 100 can be controlled at intervals narrower than α/2 without increasing the number of bits Nb of the phase shifter.

FIG. 7 illustrates the relationship between the polarization angle of linearly polarized waves transmitted/received by the plurality of antennas 11T and the polarization angle of linearly polarized waves transmitted/received by the antenna device 100.

In the example of FIG. 7, the number of plurality of antennas 11T is “N”. For example, the polarization angle of the linearly polarized waves transmitted/received by the (N−m) antennas 11T is τ1. The polarization angle of the linearly polarized waves transmitted/received by the m antennas 11T is τ2. “m” is an integer not less than 0 and not more than “N”. τ1 is different from τ2.

In FIG. 7, a vector 210a represents a linearly polarized wave that is a combination of linearly polarized waves transmitted/received by (N−m) antennas 11T. A vector 210b represents a linearly polarized wave that is a combination of linearly polarized waves transmitted/received by m antennas 11T. A vector 211 represents a linearly polarized wave that is a combination of linearly polarized waves transmitted/received by the N antennas 11T. The angle between vector 210a and the θ hat axis is τ1. The angle between vector 210b and the θ hat axis is τ2. The angle between vector 211 and the θ hat axis is τ0.

In FIG. 7, the polarization angle of the linearly polarized waves transmitted/received by the first antenna 11a1 to the (N−m)-th antenna 11a (N−m) is τ1. The polarization angle of the linearly polarized waves transmitted/received by the (N−m+1)-th antenna 11a (N−m+1) to the N-th antenna 11aN is assumed to be τ2.

τ0, τ1, and τ2 satisfy the relationship of formula (6).

$${τ}_{1} \leq {τ}_{0} \leq {τ}_{2} \qquad ( 6 )$$

In FIG. 7, “δ” is defined by formula (7).

$$δ = {τ}_{2} - {τ}_{1} \qquad ( 7 )$$

The amplitude of the linearly polarized wave transmitted/received by the k-th antenna 11ak (k is an integer not less than 1 and not more than “N”) is defined as “aₖ”. The θ hat component E_{θ1} of the vector 210a and the ϕ hat component E_{ϕ1} of the vector 210a are expressed by formula (8).

$$( {E}_{{θ}_{1}} , {E}_{{ϕ}_{1}} ) = ( {\sum }_{k = 1}^{N - m} {a}_{k} cos {τ}_{1} , {\sum }_{k = 1}^{N - m} {a}_{k} sin {τ}_{1} ) \qquad ( 8 )$$

The θ hat component E_{θ1} of the vector 210b and the ϕ hat component E_{ϕ2} of the vector 210b are expressed by formula (9).

$$( {E}_{2} , {E}_{{ϕ}_{2}} ) = ( {\sum }_{k = N - m + 1}^{N} {a}_{k} cos {τ}_{2} , {\sum }_{k = N - m + 1}^{N} {a}_{k} sin {τ}_{2} ) \qquad ( 9 )$$

At this time, the relationship of formula (10) is satisfied for the polarization angle τ0.

$$tan {τ}_{0} = \frac{{\sum }_{k = 1}^{N - m} {a}_{k} sin {τ}_{1} + {\sum }_{k = N - m + 1}^{N} {a}_{k} sin {τ}_{2}}{{\sum }_{k = 1}^{N - m} {a}_{k} cos {τ}_{1} + {\sum }_{k = N - m + 1}^{N} {a}_{k} cos {τ}_{2}} \qquad ( 10 )$$

The polarization angle of the target linearly polarized waves that the antenna device 100 transmits/receives is defined as τ0. It is assumed that the polarization angle of the linearly polarized waves transmitted/received by the plurality of antennas 11T is either τ1 or τ2. At this time, by solving formula (10) for “m”, it is possible to determine the polarization angle of the linearly polarized waves transmitted/received by each of the plurality of antennas 11T.

The control circuit 115 determines either τ1 or τ2 for each polarization angle of the plurality of antennas 11T, for example, based on “m” obtained by solving formula (10). The control circuit 115 controls the phase shift amount of the plurality of left phase shifters 12L and the phase shift amount of the plurality of right phase shifters, for example, based on the determination.

For example, it is assumed that the amplitude of the linearly polarized waves transmitted/received by the plurality of antennas 11T is 1. At this time, the length of the vector 210a is (N−m). The length of vector 210b is “m”. At this time, formula (11) is obtained by transforming formula (10).

$$tan {τ}_{0} = \frac{( N - m ) sin {τ}_{1} + m sin {τ}_{2}}{( N - m ) cos {τ}_{1} + m cos {τ}_{2}} \qquad ( 11 )$$

Formula (12) is obtained by solving Formula (11) for “m”.

$$m = \frac{tan {τ}_{0} cos {τ}_{1} - sin {τ}_{1}}{tan {τ}_{0} ( cos {τ}_{1} - cos {τ}_{2} ) + ( sin {τ}_{2} - sin {τ}_{1} )} \times N \qquad ( 12 )$$

By transforming formula (12), formula (13) is obtained.

$$m = \frac{tan {τ}_{0} cos {τ}_{1} - sin {τ}_{1}}{2 tan {τ}_{0} sin \frac{{τ}_{1} + {τ}_{2}}{2} sin \frac{{τ}_{2} - {τ}_{1}}{2} + 2 cos \frac{{τ}_{1} + {τ}_{2}}{2} sin \frac{{τ}_{2} - {τ}_{1}}{2}} \times N \qquad ( 13 )$$

By substituting formula (7) into formula (13), formula (14) is obtained.

$$m = \frac{tan {τ}_{0} cos {τ}_{1} - sin {τ}_{1}}{2 {tan}_{0} sin ( {τ}_{1} + \frac{δ}{2} ) sin \frac{δ}{2} + 2 cos ( {τ}_{1} + \frac{δ}{2} ) sin \frac{δ}{2}} \times N \qquad ( 14 )$$

Formula (15) is obtained by transforming Formula (14).

$$( 15 )$$

$$m = \frac{( tan {τ}_{0} cos {τ}_{1} - sin {τ}_{1} )}{2 sin \frac{δ}{2} \{ tan {τ}_{0} ( sin {τ}_{1} cos \frac{δ}{2} + cos {τ}_{1} sin \frac{δ}{2} ) + cos {τ}_{1} cos \frac{δ}{2} - sin {τ}_{1} sin \frac{δ}{2} \}} \times N$$

Here, it is assumed that “δ” (in radian units) is sufficiently smaller than 1, and the second-order minute term is ignored. Formula (16) is obtained as an approximation of Formula (15).

$$m ≅ \frac{tan {τ}_{0} cos {τ}_{1} - sin {τ}_{1}}{δ \{ tan {τ}_{0} ( sin {τ}_{1} + \frac{δ}{2} cos {τ}_{1} ) + cos {τ}_{1} - \frac{δ}{2} sin {τ}_{1} \}} \times N \qquad ( 16 )$$

If the second-order minute term of formula (16) is ignored, formula (17) is obtained as an approximate formula of formula (16).

$$m ≅ \frac{tan {τ}_{0} cos {τ}_{1} - sin {τ}_{1}}{δ \{ tan {τ}_{0} sin {τ}_{1} + cos {τ}_{1} \}} \times N \qquad ( 17 )$$

By transforming formula (17), formula (18) is obtained.

$$m ≅ \frac{tan ( {τ}_{0} - {τ}_{1} )}{δ} \times N \qquad ( 18 )$$

When “δ” is equal to half the minimum phase shift amount α/2, formula (19) is obtained from formula (18).

$$m ≅ \frac{tan ( {τ}_{0} - {τ}_{1} )}{\frac{α}{2}} \times N \qquad ( 19 )$$

When “δ” is equal to half the minimum phase shift amount (α/2), the difference between τ0 and τ1 is equal to or less than α/2 from the relationship in formula (6). When the minimum phase shift amount α (in radian) is sufficiently smaller than 1, formula (20) is obtained as an approximate formula of formula (19).

$$m ≅ \frac{{τ}_{0} - {τ}_{1}}{\frac{α}{2}} \times N \qquad ( 20 )$$

When formula (20) is solved for τ0, formula (21) is obtained.

$${τ}_{0} ≅ {τ}_{1} + \frac{α}{2 N} m \qquad ( 21 )$$

When formula (20) holds, the polarization angle transmitted/received by the antenna device 100 is substantially an integer multiple of α/(2N) and is variable from formula (21).

When “δ” is sufficiently smaller than 1 and “N” is sufficiently large, the polarization angle of the linearly polarized waves transmitted/received by the antenna device 100 becomes substantially continuously variable.

For example, it is assumed that the number of bits Nb of the plurality of left phase shifters 12L and the plurality of right phase shifters 12R is six. It is assumed that the number of plurality of antennas 11T (i.e., N) is 1,000. At this time, α is 360°/(2\hat{ }6)=5.625°. That is, α is approximately 0.098 radian, which is sufficiently smaller than 1. From formula (21), TO is variable at intervals of approximately 0.0028125°.

At this time, the maximum error between the target polarization angle and the polarization angle of the linearly polarized waves transmitted/received by the antenna device 100 is approximately α/(4N) (approximately 0.00140625°). E_{Co} in formula (4) is cos) (0.00140625°. E_{X} in formula (4) is sin (0.00140625°). From formula (4), the minimum value of XPD is approximately 92 decibels.

For example, the number of bits Nb of the plurality of left phase shifters 12L and the plurality of right phase shifters 12R is 6, and the plurality of antennas 11T are controlled to transmit/receive linearly polarized waves having substantially the same polarization angle. In this case, from formula (4), the minimum value of XPD is approximately 26 decibels.

In the embodiment, the antenna device 100 transmits/receives linearly polarized waves by combining right-handed circularly polarized waves and left-handed circularly polarized waves. In the antenna device 100, it is possible to control the polarization angle of the linearly polarized waves transmitted/received by the antenna device 100 at intervals narrower than half (α/2) of the minimum phase shift amount α, without increasing the number of bits Nb of the plurality of left phase shifters 12L and the plurality of right phase shifters.

According to the embodiment, for example, the error between the polarization angle of the target linearly polarized wave that the antenna device 100 transmits/receives and the polarization angle of the linearly polarized wave that the antenna device 100 actually transmits/receives is reduced.

According to the embodiment, it is possible to finely adjust the polarization angle of linearly polarized waves transmitted/received by the antenna device 100, for example, using a digital phase shifter with a small number of bits Nb. A low-cost antenna device 100 can be provided.

In the embodiment, when the antenna device 100 is a transmitting antenna, the following configuration may be applied. The plurality of left phase shifters 12L include the first left phase shifter 12a1 and the second left phase shifter 12a2 (see FIG. 1). The first left phase shifter 12a1 is configured to discretely control the first left phase of the first left-handed circularly polarized signal SL1 (see FIG. 1). The second left phase shifter 12a2 is configured to discretely control the second left phase of the second left-handed circularly polarized signal SL2 (see FIG. 1).

In the embodiment, the plurality of right phase shifters 12R include the first right phase shifter 12b1 and the second right phase shifter 12b2 (see FIG. 1). The first right phase shifter 12b1 is configured to discretely control the first right phase of the first right-handed circularly polarized signal SR1 (see FIG. 1). The second right phase shifter 12b2 is configured to discretely control the second right phase of the second right-handed circularly polarized signal SR2 (see FIG. 1).

In the embodiment, the plurality of antennas 11T include the first antenna 11a1 and the second antenna 11a2 (see FIG. 1). For example, the first left phase shifter 12a1 is configured to supply the first left-handed circularly polarized signal SL1 to the first antenna 11a1. The first right phase shifter 12b1 is configured to supply the first right-handed circularly polarized signal SR1 to the first antenna 11a1. For example, the first antenna 11a1 is configured to transmit a first left-handed circularly polarized wave based on the first left-handed circularly polarized signal SL1 and a first right-handed circularly polarized wave based on the first right-handed circularly polarized signal SR1.

For example, the second left phase shifter 12a2 is configured to supply the second left-handed circularly polarized signal SL2 to the second antenna 11a2. The second right phase shifter 12b2 is configured to supply the second right-handed circularly polarized signal SR2 to the second antenna 11a2. For example, the second antenna 11a2 transmits a second left-handed circularly polarized wave based on the second left-handed circularly polarized signal SL2 and a second right-handed circularly polarized wave based on the second right-handed circularly polarized signal SR2.

In the embodiment, the first polarization angle (e.g., τ1) of the first linearly polarized wave generated by the first left-handed circularly polarized wave and the first right-handed circularly polarized wave is different from the second polarization angle (for example, τ2) of the second linearly polarized wave generated by the second left-handed circularly polarized wave and the second right-handed circularly polarized wave. For example, the polarization angle of linearly polarized waves transmitted by the antenna device 100 can be finely adjusted. According to the embodiment, it is possible to provide an antenna device with improved characteristics.

In the embodiment, for example, the N-th left phase shifter 12aN is configured to discretely control the N-th left phase of the N-th left-handed circularly polarized signal SLN (see FIG. 1). For example, the N-th right phase shifter 12bN is configured to discretely control the N-th right phase of the N-th right-handed circularly polarized signal SRN. For example, the N-th left phase shifter 12aN is configured to supply the N-th left-handed circularly polarized signal SLN to the N-th antenna 11aN. The N-th right phase shifter 12bN is configured to supply the N-th right-handed circularly polarized signal SRN to the N-th antenna 11aN. For example, the N-th antenna 11aN is configured to transmit the first left-handed circularly polarized wave based on the N-th left-handed circularly polarized signal SLN and the N-th right-handed circularly polarized wave based on the N-th right-handed circularly polarized signal SRN.

Hereinafter, some examples of polarization angle control will be explained.

FIG. 8 is a graph illustrating the characteristics of the antenna device according to the first embodiment.

FIG. 8 shows the relationship between the polarization angle PA of linearly polarized waves received by the antenna device 100 and the received power Pr.

Generally, when the antenna device 100 receives linearly polarized waves for communication, the control circuit 115 controls the N left phase shifters 12L, N right phase shifters 12R, and the signal processing circuit 110. When the received power Pr is large, the signal-to-noise ratio becomes high, so communication quality improves.

On the other hand, the antenna device 100 may be used as a radar that detects linearly polarized waves received by the antenna device 100. At this time, the antenna device 100 may be controlled so that the received power Pr becomes the minimum when receiving the linearly polarized signal arriving at the antenna device 100.

A peak search technique and a null search technique are known as methods for estimating radio waves arriving at the antenna device 100. In the peak search technique, the point where the radiation directivity is maximum is scanned, and the beam direction where the received power Pr is maximum is estimated as the arrival direction of the radio wave. In the null search technique, a point (null point) where the radiation directivity is the minimum is scanned, and the beam direction where the received power Pr is the minimum is estimated as the arrival direction of the radio wave. For example, the MUSIC (Multiple Signal Classification) method is known as a null search technique.

In the null search, compared to the peak search, the fluctuation of the received power Pr near the beam direction is large, and the estimation accuracy of the arrival direction of the radio wave is high.

FIG. 8 shows the relationship between the polarization angle PA of the linearly polarized wave received by the antenna device 100 and the received power Pr. FIG. 8 shows an example of the relationship between the polarization angle PA and the received power Pr when the beam direction is fixed in the antenna device 100 and the polarization angle PA of the linearly polarized wave to be received is rotated. In FIG. 8, the polarization angle PA of the linearly polarized wave arriving at the antenna device 100 is defined as T.

In FIG. 8, the received power Pr of the antenna device 100 is maximum when the polarization angle PA received by the antenna device 100 is τ. The received power Pr of the antenna device 100 becomes minimum when the polarization angle PA received by the antenna device 100 is set to τ+90°. When estimating the polarization angle PA of the linearly polarized wave arriving at the antenna device 100, a null search may be applied. At this time, the polarization angle PA (τ) of the arriving linearly polarized wave can be estimated based on the polarization angle PA (τ+90°) when the received power Pr of the antenna device 100 is minimum.

In the embodiment, according to the above example, the accuracy of estimating the polarization angle PA of the linearly polarized wave arriving at the antenna device 100 can be improved by using the null search technique.

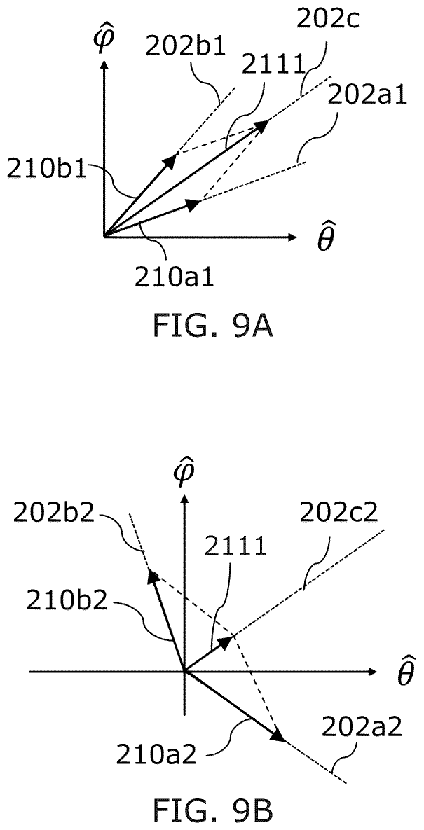

FIGS. 9A and 9B are schematic diagrams illustrating the antenna device according to the first embodiment.

FIGS. 9A and 9B illustrate the relationship between the linearly polarized waves transmitted/received by each of the N antennas 11T included in the antenna device 100 and the polarization angle of the linearly polarized waves transmitted/received by the antenna device 100.

The vector 210a1 represents a linearly polarized wave that is a combination of linearly polarized waves with a polarization angle τ1 transmitted/received by (N−m) antennas 11T. The vector 210b1 represents a linearly polarized wave that is a combination of linearly polarized waves with a polarization angle τ2 transmitted/received by the N antennas 11T. The angle between the vector 210a1 and the θ hat axis is defined as τ1. The angle between the vector 210b1 and the θ hat axis2 is defined as τ2. τ1 is smaller than τ2. The angle between a vector 2111 and the θ hat axis is defined as τ0.

The minimum phase shift amount of the phase shifter included in the antenna device 100 is defined as “α”. τ1 and τ2 are each substantially an integer multiple of α/2, and can be set to arbitrary values. It is preferable that the difference between τ1 and τ2 is small. The vector 2111 is generated by combining vector 210a1 and vector 210b1. In the vector 210a1 and the vector 210b1, components orthogonal to τ0 cancel each other out. That is, when the difference between τ1 and τ2 is small, the power transmitted/received by the antenna device 100 is large. When the difference between τ1 and τ2 is large, the power transmitted/received by the antenna device 100 is small.

The length of the vector 2111 in FIG. 9A is longer than the vector 2111 in FIG. 9B. When the difference between τ1 and τ2 is large, the power of linearly polarized waves transmitted/received by the antenna device 100 decreases. The reduction in power for transmitting/receiving causes problems such as deterioration of communication quality. Therefore, the difference between τ1 and τ2 is preferably small.

τ1 and τ2 can be set to values that are substantially an integer multiple of α/2. For example, the minimum absolute value of the difference between τ1 and τ2 is α/2. At this time, the power of the linearly polarized waves transmitted/received by the antenna device 100 becomes maximum.

In the embodiment, in the antenna device 100, it is preferable that the polarization angle of the linearly polarized waves transmitted/received by the plurality of antennas 11T is controlled so that the absolute value of the difference between τ1 and τ2 is α/2.

In the embodiment, for example, the first left phase shift amount of the first left phase shifter 12a1 is a first integer multiple of the first minimum phase shift amount. For example, the first right phase shift amount of the first right phase shifter 12b1 is a second integer multiple of the second minimum phase shift amount. The first minimum phase shift amount is substantially the same as the second minimum phase shift amount. The first minimum phase shift amount and the second minimum phase shift amount are substantially the above minimum phase shift amount α. In the embodiment, the absolute value of the difference between the first polarization angle (for example, τ1) and the second polarization angle (for example, τ2) is, for example, not less than 0.45 times and not more than 0.55 times the first minimum phase shift amount. The absolute value of the difference may be, for example, not less than 0.45 times and not more than 0.55 times the second minimum phase shift amount. For example, power loss can be suppressed.

For example, the antenna device 100 may include an Nb-bit phase shifter and an Mb-bit phase shifter. “Nb” is different from “Mb2. The antenna device 100 includes N antennas 11T. For example, (N−m) antennas 11T are coupled with an Nb-bit left phase shifter and an Nb-bit right phase shifter. The (N−m) antennas 11T transmit/receive linearly polarized waves with a polarization angle τ1. For example, the m antennas 11T are coupled with an Mb-bit left phase shifter and an Mb-bit right phase shifter. The m antennas 11T transmit/receive linearly polarized waves with a polarization angle τ2.

It is preferable that the difference between τ1 and τ2 is small. For example, T1 is controlled to be an integer multiple of 180°/(2\hat{ }Nb). For example, τ2 is controlled to be substantially an integer multiple of 180°/(2\hat{ }Mb). For example, the absolute value of the difference between τ1 and τ2 may be less than half of the larger value of 180°/(2\hat{N}b) and 180°/(2\hat{ }Mb). At this time, the amount of cancellation of the component orthogonal to TO among the transmitted/received power becomes the minimum.

In the embodiment, it is preferable that the polarization angle of the plurality of antennas 11T is controlled so that the absolute value of the difference between τ1 and τ2 is half of the larger value of 180°/(2\hat{ }Nb) and 180°/(2\hat{ }Mb).

In the embodiment, the first left phase shift amount of the first left phase shifter 12a1 is a first integer multiple of the first minimum phase shift amount. The first right phase shift amount of the first right phase shifter 12b1 is a second integer multiple of the second minimum phase shift amount. The first minimum phase shift amount is larger than the second minimum phase shift amount. In the embodiment, the difference between the first polarization angle and the second polarization angle is not more than 0.55 times the first minimum phase shift amount. For example, power loss can be suppressed.

In the embodiment, when the antenna device 100 is a transmitting antenna, the following configuration may be applied. The plurality of antennas 11T include the first antenna 11a1 and the second antenna 11a2. The first antenna 11a1 is configured to receive left-handed circularly polarized waves and right-handed circularly polarized waves, and output a first left-handed circularly polarized signal SL1 and a first right-handed circularly polarized signal SR1 (see FIG. 1). The second antenna 11a2 is configured to receive the left-handed circularly polarized waves and the right-handed circularly polarized waves, and output the second left-handed circularly polarized signal SL2 and the second right-handed circularly polarized signal SR2 (see FIG. 1).

The plurality of left phase shifters 12L include the first left phase shifter 12a1 and the second left phase shifter 12a2. The first left phase shifter 12a1 is configured to discretely control the first left phase of the first left-handed circularly polarized signal SL1. The second left phase shifter 12a2 is configured to discretely control the second left phase of the second left-handed circularly polarized signal SL2. The plurality of right phase shifters 12R include the first right phase shifter 12b1 and the second right phase shifter 12b2. The first right phase shifter 12b1 is configured to discretely control the first right phase of the first right-handed circularly polarized signal SR1. The second right phase shifter 12b2 is configured to discretely control the second right phase of the second right-handed circularly polarized signal SR2.

The signal processing circuit 110 (see FIG. 1) is configured to be coupled to the plurality of left phase shifters 12L and the plurality of right phase shifters 12R. The signal processing circuit 110 is configured to generate a linear polarization signal indicating linear polarization from the first left-handed circularly polarized signal SL1, the first right-handed circularly polarized signal SR1, the second left-handed circularly polarized signal SL2, and the second right-handed circularly polarized signal SR2. In this case, the signal processing circuit 110 may be, for example, a power combiner.

In the embodiment, the first polarization angle (for example, τ1) of the first linearly polarized signal generated from the first left-handed circularly polarized signal SL1 and the first right-handed circularly polarized signal SR1 is different from the second polarization angle (for example, τ2) of the second linearly polarized signal generated from the second left-handed circularly polarized signal SL2 and the second right-handed circularly polarized signal SR2. For example, the first left phase shift amount of the first left phase shifter, the second left phase shift amount of the second left phase shifter, the first right phase shift amount of the first right phase shifter, and the second right phase shift amount of the second phase shifter satisfies at least one of a first condition or a second condition. In the first condition, the first left phase shift amount is different from the second left phase shift amount. In the second condition, the first right phase shift amount is different from the second right phase shift amount. With such a configuration, for example, it is possible to receive radio waves with high accuracy and high efficiency. It is possible to provide an antenna device for receiving whose characteristics can be improved.

The first left phase shifter 12a1, the first right phase shifter 12b1, the second left phase shifter 12a2, and the second right phase shifter 12b2 may satisfy any one of a third condition and a fourth condition. In the third condition, the relative first phase shift amount between the first left phase shifter 12a1 and the first right phase shifter 12b1 is controlled so that the linearly polarized signal generated (synthesized) by the signal processing circuit 110 is maximized when the first antenna 11a1 receives the first linearly polarized wave with the first polarization angle. In the third condition, the relative second phase shift amount between the second left phase shifter 12a2 and the second right phase shifter 12b2 is controlled so that the linearly polarized signal generated (synthesized) by the signal processing circuit 110 is maximized when the second antenna 11a2 receives the second linearly polarized wave at the second polarization angle. For example, a peak search is performed in which the direction of arrival is estimated by changing the direction of arrival where the received power is maximum.

In the fourth condition, the first phase shift amount is controlled so that the linearly polarized signal generated (combined) by the signal processing circuit 110 is minimized when the first antenna 11a1 receives the first linearly polarized wave. In the fourth condition, the second phase shift amount is controlled so that the linearly polarized signal generated (combined) by the signal processing circuit 110 is minimized when the second antenna 11a2 receives the second linearly polarized wave. For example, a null search is performed to estimate the direction of arrival by changing the direction of arrival where the received power is minimum.

For example, the difference between the first polarization angle and second polarization angle is generated by changing at least one of the first left phase shift amount, the second left phase shift amount, the first right phase shift amount, or the second right phase shift amount. For example, the control circuit 115 is configured to control at least one of the first phase shift amount or the second phase shift amount.

### Second Embodiment

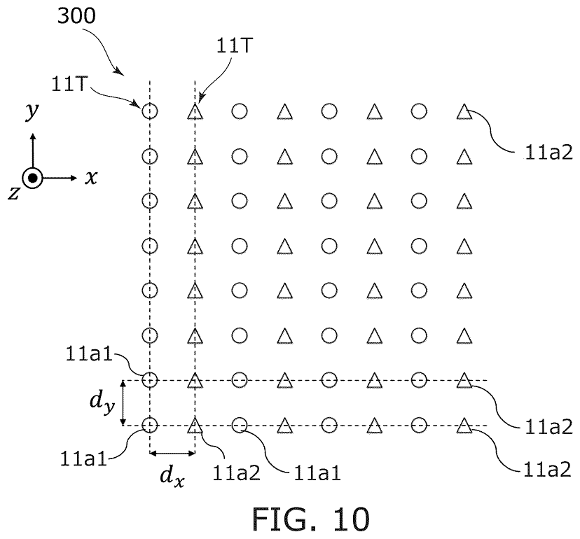

FIG. 10 is a schematic diagram illustrating an antenna device according to a second embodiment.

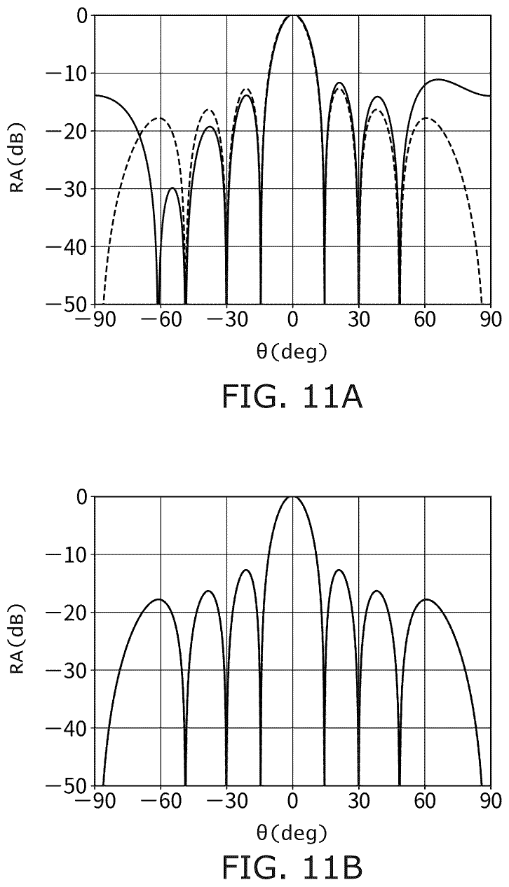

FIGS. 11A and 11B are graphs illustrating the characteristics of the antenna device.

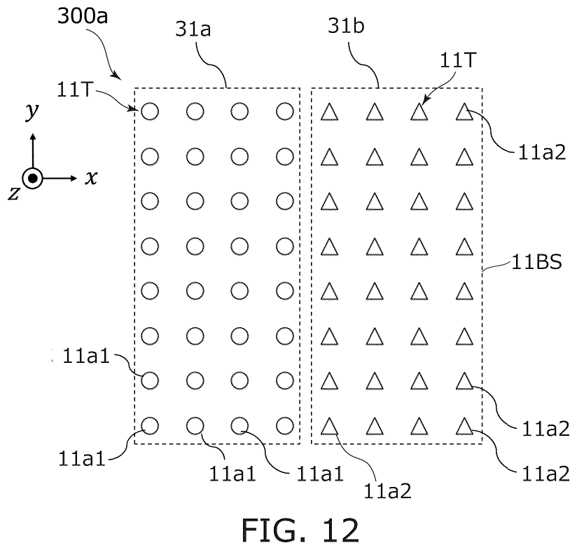

FIG. 12 is a schematic diagram illustrating the antenna device according to the second embodiment.

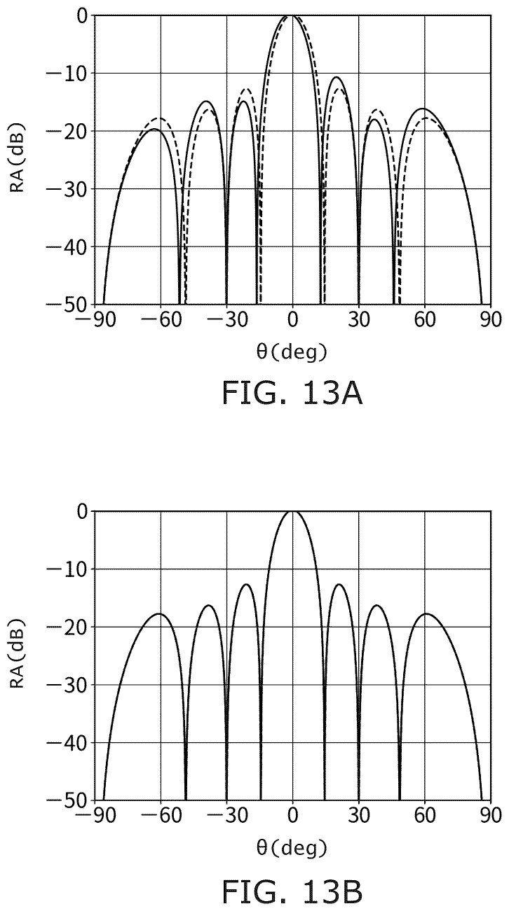

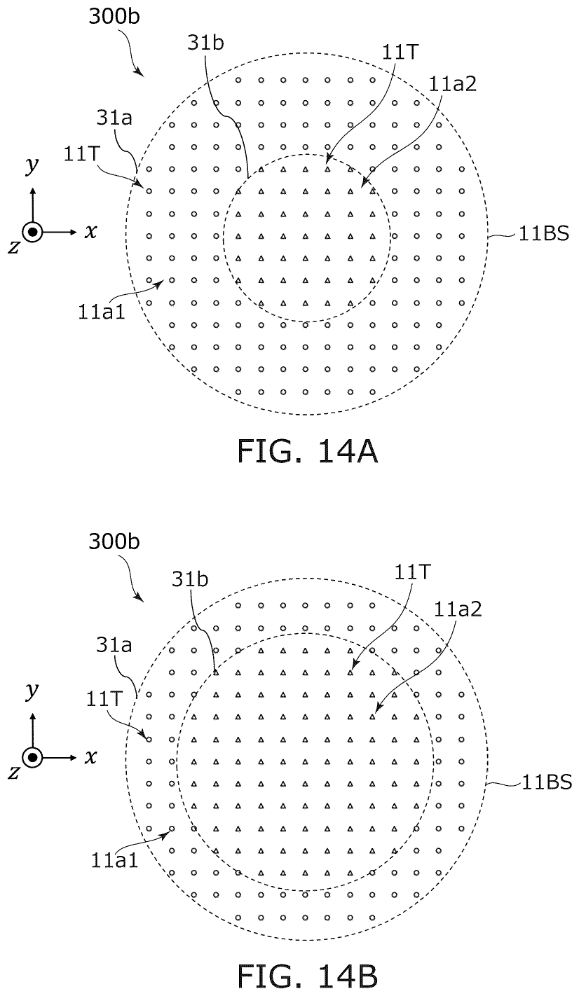

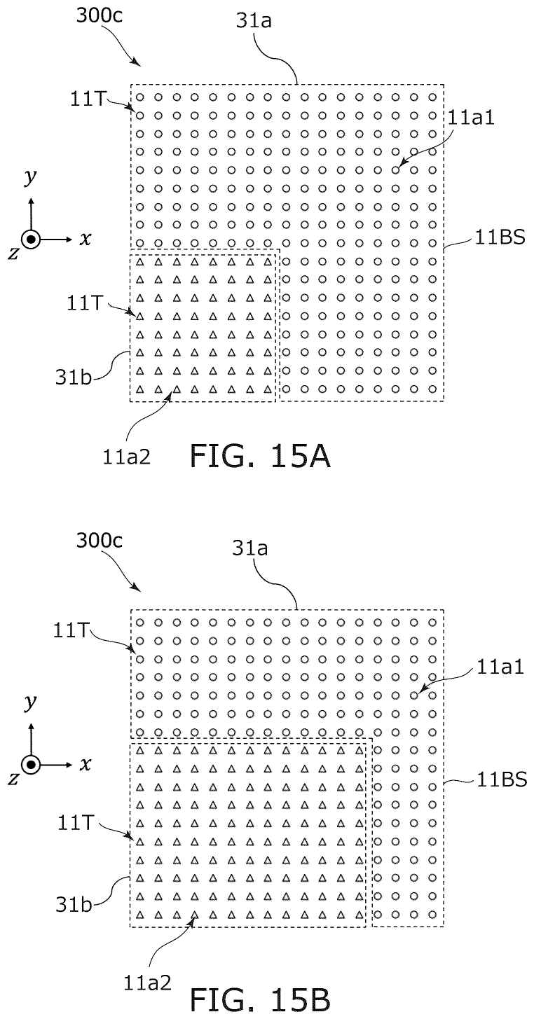

FIGS. 13A and 13B are graphs illustrating the characteristics of the antenna device according to the second embodiment.

14A and 14B are schematic diagrams illustrating the antenna device according to a second embodiment.

15A and 15B are schematic diagrams illustrating the antenna device according to a second embodiment.

For example, in the antenna, the plane of polarization of linearly polarized waves transmitted/received by the antenna is rotated by combining right-handed circularly polarized waves and left-handed circularly polarized waves. By changing the relative phase shift amount between the right-handed circularly polarized wave and the left-handed circularly polarized wave, the plane of polarization of the linearly polarized wave is rotated.

For example, the polarization angle of the linearly polarized waves transmitted/received by the plurality of antennas 11T differs for each antenna. For example, the relative phase shift amount between right-handed circularly polarized waves and left-handed circularly polarized waves transmitted/received by the plurality of antennas 11T differs depending on the antenna.

In an array antenna including the plurality of antennas 11T, unnecessary radiation occurs when at least one of the amplitude or phase of radio waves transmitted/received by the plurality of antennas 11T changes periodically. Unwanted radiation includes, for example, grating lobes.

A problem arises when grating lobes occur. For example, the power of radio waves transmitted/received by the antenna device decreases. For example, grating lobes become interference waves for other communications.

As illustrated in FIG. 10, an antenna device 300 according to the embodiment includes a plurality of antennas 11T. In this example, the number of plurality of antennas 11T is 64. Circles in FIG. 10 indicate the first antenna 11a1. The triangles in FIG. 10 indicate the second antenna 11a2. The antenna device 300 includes the plurality of left phase shifters 12L, the plurality of right phase shifters 12R, the signal processing circuit 110, and the control circuit 115, which are described in the first embodiment. In the antenna device 300, the plurality of antennas 11T are configured to transmit/receive right-handed circularly polarized waves and left-handed circularly polarized waves. In the antenna device 300, the amplitudes and phases of radio waves transmitted/received may be different from each other in the plurality of antennas 11T.

In the antenna device 300, eight antennas 11T are arranged in an x-axis direction. Eight antennas 11T are arranged in a y-axis direction. In the plurality of antennas 11T, the element interval dx in the x-axis direction is 150 mm. The element interval dy in the y-axis direction is 150 mm. The 64 antennas 11T are arranged at evenly intervals in the x-axis direction and the y-axis direction. In the plurality of antennas 11T, the element interval may not be the same. For example, the plurality of antennas 11T may be arranged in a triangular arrangement. In the triangular arrangement, a plurality of antennas 11T are arranged in a triangular lattice shape. The distances between the plurality of antennas 11T may be different from each other.

In FIG. 10, the phase of the radio waves transmitted/received by the first antennas 11a1 indicated by the circles is 0°. The phase of the radio waves transmitted/received by the second antennas 11a2 indicated by the triangles is 22.5°. The relative phase shift difference between the first antenna 11a1 and the second antenna 11a2 is substantially equal to the minimum phase shift amount of the 4-bit phase shifter. In this example, the 32 first antennas 11a1 indicated by circles transmit/receive radio waves with a phase shift of 0°. The 32 second antennas 11a2 indicated by triangles transmit/receive radio waves with a phase of 22.5°.

In the example shown in FIG. 10, the 32 first antennas 11a1 transmit/receive linearly polarized waves with a polarization angle of 0°. The 32 second antennas 11a2 transmit/receive linearly polarized waves with a polarization angle of 11.25°. The linearly polarized waves transmitted/received by the 64 antennas 11T are combined. The antenna device 300 corresponds to an array antenna that transmits/receives linearly polarized waves with a polarization angle of substantially 5.625°. In the example shown in FIG. 10, the phase of radio waves transmitted/received by the plurality of antennas 11T changes periodically on the x-axis.

FIGS. 11A and 11B show examples of calculation results of radiation directivity. In the example of FIGS. 11A and 11B, 64 antennas 11T are calculated as omnidirectional antennas. In the example of FIGS. 11A and 11B, the powers transmitted/received by the 64 antennas are substantially equal to each other. In FIGS. 11A and 11B, the frequency is 1 GHz.

FIG. 11A shows an example of radiation directivity in a plane parallel to the x-axis. FIG. 11B shows an example of radiation directivity in a plane parallel to the y-axis. In FIGS. 11A and 11B, the solid line corresponds to the radiation directivity of the antenna device 300. In FIGS. 11A and 11B, the broken lines correspond to radiation directivity when the phase of radio waves transmitted/received by all 64 antennas 11T is 0°. In FIG. 11B, the broken line overlaps the solid line. In FIGS. 11A and 11B, the solid line characteristics are normalized by the maximum value in the solid line. The broken line properties are normalized by the maximum value in the broken line. In FIGS. 11A and 11B, the horizontal axis is the angle θ. The vertical axis is relative intensity RA (Relative Amplitude).

When the phase of radio waves transmitted/received by all 64 antennas 11T is 0°, the radiation directivity is maximum when the angle θ is 0°. That is, the angle θ in the beam direction is 0°.

In FIG. 11A (radiation directivity in a plane parallel to the x-axis), the radiation directivity indicated by the solid line is different from the radiation directivity indicated by the broken line. The value of the radiation directivity shown by the solid line is larger at an angle of ±90° compared to the radiation directivity shown by the broken line. In FIG. 11B (radiation directivity in a plane parallel to the y-axis), the calculation results shown by the solid line are substantially consistent with the calculation results shown by the broken line, regardless of the angle θ.

From the results in FIG. 11A, it can be seen that in the antenna device 300, grating lobes occur in directions where the angle θ is ±90°.

As shown in FIGS. 11A and 11B, grating lobes are generated when the phase of radio waves transmitted/received by the plurality of antennas 11T changes periodically. For example, the plurality of antennas 11T are arranged in a direction substantially parallel to the plane where radiation directivity is observed. In the plurality of antennas 11T, there is a case where at least one of the amplitude or phase of radio waves may change periodically. In such a plurality of antennas 11T, grating lobes are generated when at least one of the amplitude or phase of the plurality of antennas 11T changes periodically.

In the example shown in FIG. 10, the phase of the radio waves transmitted/received by the plurality of antennas 11T changes periodically in the x-axis direction. The phase of radio waves transmitted/received by the plurality of antennas 11T does not change periodically in the y-axis direction. A grating lobe occurs in the radiation directivity of the antenna device 300 in a plane parallel to the x-axis. No grating lobe occurs in the radiation directivity of the antenna device 300 in a plane parallel to the y-axis.

For example, in the embodiment, the periodicity of at least one of the amplitude or phase of the radio waves transmitted/received by the plurality of antennas 11T may be reduced. Thereby, for example, grating lobes of transmitted/received radio waves can be suppressed.

FIG. 12 illustrates an antenna device 300a according to the embodiment. The antenna device 300a may include the plurality of left phase shifters 12L, the plurality of right phase shifters 12R, the signal processing circuit 110, and the control circuit 115 (see FIG. 1) in addition to the plurality of antennas 11T. In the antenna device 300a, the arrangement of the first antennas 11a1 indicated by circles and the second antennas 11a2 indicated by triangles are different from the arrangement in the antenna device 300. The configuration of the antenna device 300a except for this may be the same as the configuration of the antenna device 300, for example.

As already explained, in the antenna device 300, the phase of the radio waves transmitted/received changes periodically in a plane parallel to the x-axis. In the antenna device 300, grating lobes are generated.

In the antenna device 300a, the first antennas 11a1 indicated by circles and the second antennas 11a2 indicated by triangles are not arranged alternately in the x-axis direction. In the antenna device 300a, there is no periodicity in the phase of radio waves transmitted/received by the plurality of antennas 11T. In the antenna device 300a, grating lobes are reduced compared to antenna device 300.

In FIG. 12, the first antennas 11a1 indicated by circles are provided in a first partial region 31a. The second antennas 11a2 indicated by triangles are provided in a second partial region 31b. In FIG. 12, the first partial region 31a and the second partial region 31b are rectangular. The first partial region 31a and the second partial region 31b are in contact with each other along a plane parallel to the y-axis. In the antenna device 300a, a part of the plurality of antennas 11T is provided in the first partial region 31a. Another part of the plurality of antennas 11T is provided in the second partial region 31b.

For example, the antenna device 300a may include a base 11BS. The base 11BS may be a substrate or the like. The plurality of antennas 11T are provided on the base 11BS. The base 11BS includes, for example, the first partial region 31a being continuous and the second partial region 31b being continuous. The plurality of antennas 11T may include, for example, a plurality of first antennas 11a1 and a plurality of second antennas 11a2. For example, the plurality of first antennas 11a1 are part of the plurality of antennas 11T. For example, the plurality of second antennas 11a2 are another part of the plurality of antennas 11T. The plurality of first antennas 11a1 are provided in the first partial region 31a. The plurality of first antennas 11a1 are not provided in the second partial region 31b. The plurality of second antennas 11a2 are provided in the second partial region 31b. The plurality of second antennas 11a2 are not provided in the first partial region 31a. Such a configuration suppresses grating lobes. Such a configuration may be applied when the antenna device according to the embodiment is used for at least one of transmitting or receiving.

FIGS. 13A and 13B show examples of calculation results of the radiation directivity of the antenna device 300a. In FIGS. 13A and 13B, 64 antennas 11T are omnidirectional antennas. In FIGS. 13A and 13B, the frequency is 1 GHZ. In FIGS. 13A and 13B, the powers transmitted/received by the 64 antennas 11T are substantially equal to each other. FIG. 13A shows the radiation directivity in a plane parallel to the x-axis. FIG. 13B shows the radiation directivity in a plane parallel to the y-axis. In FIGS. 13A and 13B, the solid line corresponds to the radiation directivity of the antenna device 300a shown in FIG. 12. FIGS. 13A and 13B correspond to the radiation directivity when the phase of radio waves transmitted/received by all 64 antennas 11T is 0°.

In FIGS. 13A and 13B, the solid line characteristics are normalized by the maximum value in the solid line. The broken line properties are normalized by the maximum value in the broken line. In FIG. 13B, the broken line overlaps the solid line. In FIGS. 13A and 13B, the horizontal axis is the angle θ. The vertical axis is the relative intensity RA.

It can be seen that the grating lobes in the radiation directivity shown in FIG. 13A are suppressed compared to the grating in the radiation directivity shown in FIG. 11A. In FIG. 11B and FIG. 13B, the radiation directivity is generally the same.

In the embodiment, when the relative phase shift amount of the radio waves to be transmitted/received differs among the plurality of antennas 11T, it is preferable to reduce the periodicity of the arrangement of the antennas whose relative phase shift amounts of the radio waves to be transmitted/received are different. Thereby, for example, radiation-directed grating lobes can be suppressed.

For example, the antenna device is divided into plurality of partial regions. The relative phase shifts of the radio waves transmitted/received by the antenna 11T included in one of the plurality of partial regions are equal to each other. The relative phase shifts of the radio waves transmitted/received by the antenna 11T included in another one of the plurality of partial regions are equal to each other. The antennas 11T included in one of the plurality of partial region and the antennas 11T included in another one of the plurality of partial regions have different relative phase shifts of radio waves to be transmitted/received. Thereby, the periodicity of the arrangement of antennas having different relative phase shifts can be reduced.

For example, it is preferable that the number of the plurality of partial regions provided in the antenna device is small. When the number of the plurality of partial regions is large, for example, periodicity tends to occur in the arrangement of antennas in which the relative phase shift amount of the radio waves to be transmitted/received is different. For example, grating lobes tend to increase.

The shape of each of the plurality of partial regions may be, for example, a rectangle. The shape of each of the plurality of partial regions is arbitrary. The shape of each of the plurality of partial regions may be, for example, circular or polygonal. At least one of the plurality of partial regions may be planer, for example. At least one of the plurality of partial regions may have a three-dimensional shape, for example.

FIS. 14A and 14B show an antenna device 300b according to an embodiment. The antenna device 300b may include the plurality of left phase shifters 12L, the plurality of right phase shifters 12R, the signal processing circuit 110, and the control circuit 115 (see FIG. 1) in addition to the plurality of antennas 11T. In FIGS. 14A and 14B, circles indicate the first antenna 11a1. The triangles indicate the second antenna 11a2. In the antenna device 300b, a part of the plurality of antennas 11T is provided in the first partial region 31a. Another part of the plurality of antennas 11T is provided in the second partial region 31b. The first partial region 31a is circular. The second partial region 31b is annular. The second partial region 31b is provided around the first partial region 31a.

In the antenna device 300b, the area of the first partial region 31a and the area of the second partial region 31b are changed. Thereby, for example, the number of antennas 11T having different relative phase shifts can be changed.

The area of the first partial region 31a in FIG. 14A is larger than the area of the first partial region 31a in FIG. 14B. The area of the second partial region 31b in FIG. 14A is smaller than the area of the second partial region 31b in FIG. 14B.

In the antenna device 300b, N antennas 11T are provided. The polarization angle of the linearly polarized waves transmitted/received by the (N−m) antennas 11T is defined as τ1. The polarization angle of the linearly polarized waves transmitted/received by the m antennas 11T is defined as τ2. For example, it is assumed that the polarization angle of linearly polarized waves transmitted/received by the plurality of antennas 11T provided in the first partial region 31a is τ1. The polarization angle of the linearly polarized waves transmitted/received by the plurality of antennas 11T provided in the second partial region 31b is defined as τ2.

At this time, the target polarization angle of the linearly polarized waves transmitted/received by the antenna device 300b is set to τ0. “m” is obtained by solving formula (10). For example, the area of the first partial region 31a and the area of the second partial region 31b are changed according to the determined “m”. Thereby, for example, it is possible to control the polarization angle of linearly polarized waves transmitted/received by the antenna device 300b. For example, the shape of the first partial region 31a and the shape of the second partial region 31b are changed. Thereby, for example, it is possible to control the polarization angle of linearly polarized waves transmitted/received by the antenna device 300b.

The antenna device 300b may include the control circuit 115, for example. For example, the control circuit 115 may obtain “m” by solving formula (10). Based on the obtained “m”, the control circuit 115 may determine the area of the first partial region 31a and the area of the second partial region 31b. The control circuit 115 may determine the shape of the first partial region 31a and the shape of the second partial region 31b. The phase shift amount of the phase shifter is controlled. The polarization angle of linearly polarized waves transmitted/received by the plurality of antennas 11T is controlled.

The configuration illustrated in FIG. 14A and the configuration illustrated in FIG. 14B may be reversibly switched. For example, the plurality of antennas 11T include plurality of first antennas 11a1. The number of plurality of first antennas 11a1 in a first state is different from the number of plurality of first antennas 11a1 in a second state. For example, the plurality of antennas 11T include plurality of second antennas 11a2. The number of plurality of second antennas 11a2 in the first state is different from the number of plurality of second antennas 11a2 in the second state. The polarization angle of the linearly polarized waves transmitted/received by the plurality of antennas 11T is reversibly controlled. The number may be changed, for example, by the control circuit 115. FIG. 14A corresponds to one of the first state and the second state. FIG. 14B corresponds to the other of the first state and the second state. Such a configuration may be applied when the antenna device according to the embodiment is used for at least one of transmitting or receiving.

FIGS. 15A and 15B illustrate an antenna device 300c according to an embodiment. The antenna device 300c may include the plurality of left phase shifters 12L, the plurality of right phase shifters 12R, the signal processing circuit 110, and the control circuit 115 (see FIG. 1) in addition to the plurality of antennas 11T. In FIGS. 15A and 15B, circles indicate the first antenna 11a1. The triangles indicate the second antenna 11a2. A part of the plurality of antennas 11T is provided in the first partial region 31a. Another part of the plurality of antennas 11T is provided in the second partial region 31b. In this example, the first partial region 31a is substantially rectangular. The second partial region 31b is substantially a concave polygon.

In the antenna device 300c, the area or shape of the first partial region 31a and the second partial region 31b may be changed. Thereby, for example, it is possible to change the number of antennas in which the relative phase shift amount of radio waves to be transmitted/received differs from each other.

Two partial regions are provided in the antenna device 300a, the antenna device 300b, and the antenna device 300c. In the embodiments, more than two partial regions may be provided. The plurality of partial regions may be in contact with each other. One of the plurality of partial regions may be separated from another one of the plurality of partial regions.

In the second embodiment, the antenna device may include a plurality of subarrays. One of the plurality of subarrays includes one or more antennas 11T. For example, the antenna device may include plurality of partial regions. One of the plurality of subarrays may correspond to one of the plurality of partial regions. One of the plurality of subarrays may be formed on a separate substrate, for example. For example, the relative phase shifts of radio waves transmitted/received by all of the plurality of antennas 11T included in the plurality of subarrays may be substantially equal to each other. The relative phase shift amount of the radio waves transmitted/received by the antenna 11T included in one of the plurality of subarrays may be different from the relative phase shift amount of the radio waves transmitted/received by the antenna 11T included in another one of the plurality of subarrays. For example, the polarization angle of linearly polarized waves transmitted/received by the antenna 11T can be controlled in units of plurality of subarrays. For example, controlling plurality of phase shifters becomes easier. Control by the control circuit 115 becomes easier.

One of the plurality of subarrays may be, for example, a sequential array. In a sequential array, the plurality of antennas 11T are arranged in continuous rotation. One antenna 11T and the next antenna 11T may be excited with a phase difference provided between them.

One of the plurality of subarrays may be a linear array, a two-dimensional array, or a three-dimensional array. In the linear array, plurality of antennas 11T are arranged in a straight line. In the two-dimensional array, a plurality of antennas 11T are arranged on a plane. In the three-dimensional array, a plurality of antennas 11T are arranged three-dimensionally.

In the second embodiment, for example, the polarization angles of linearly polarized waves transmitted/received by the plurality of antennas 11T differ depending on the antennas 11T. The periodicity of the arrangement of antennas 11T whose polarization angles of linearly polarized waves to be transmitted/received are different from each other is reduced. Grating lobes can be suppressed.

In the above example, the angle θ of the beam direction for transmitting/receiving is 0°. In the embodiment, the angle of the beam direction for transmitting/receiving does not have to be 0° in the following example.

The configuration illustrated in FIG. 15A and the configuration illustrated in FIG. 15B may be reversibly switched. For example, the number of plurality of first antennas 11a1 in the first state is different from the number of plurality of first antennas 11a1 in the second state. For example, the number of plurality of second antennas 11a2 in the first state is different from the number of plurality of second antennas 11a2 in the second state. FIG. 15A corresponds to one of the first state and the second state. FIG. 15B corresponds to the other of the first state and the second state. Such a configuration may be applied when the antenna device according to the embodiment is used for at least one of transmitting or receiving.

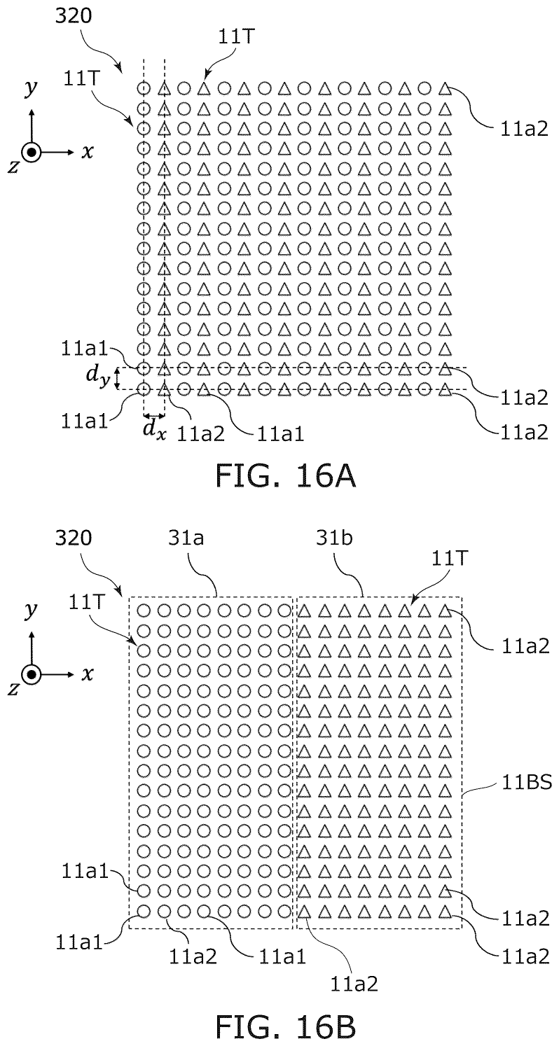

FIGS. 16A and 16B are schematic diagrams illustrating an antenna device according to the second embodiment.

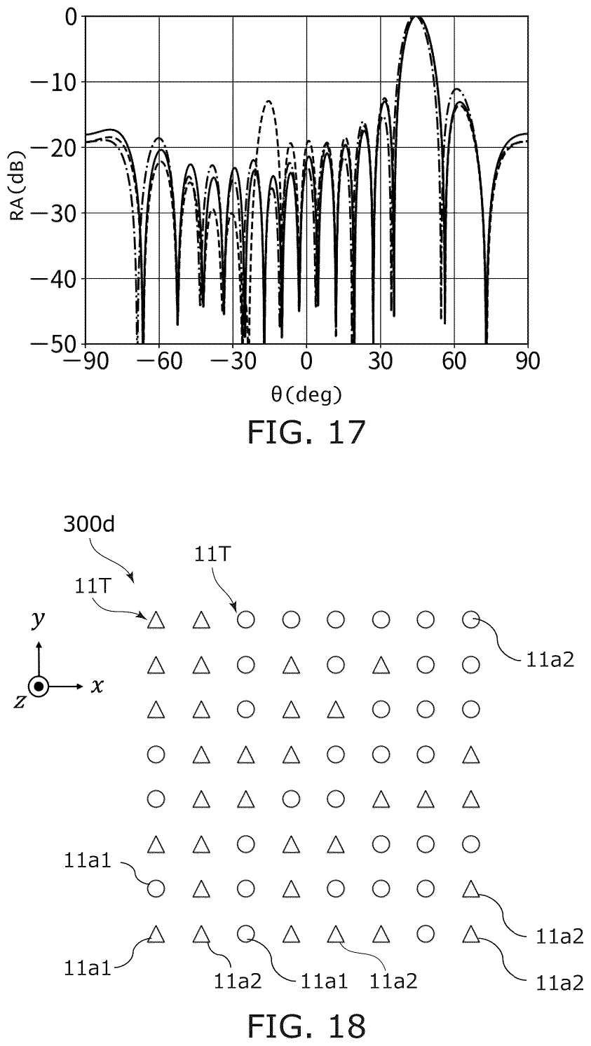

FIG. 17 is a graph illustrating the characteristics of the antenna device according to the second embodiment.

An antenna device 320 illustrated in FIGS. 16A and 16B includes the plurality of antennas 11T. The antenna device 320 may include the plurality of left phase shifters 12L, the plurality of right phase shifters 12R, the signal processing circuit 110, and the control circuit 115 (see FIG. 1).

As illustrated in FIGS. 16A and 16B, the antenna device 320 according to the embodiment includes 256 antennas 11T. The 256 antennas 11T include the plurality of first antennas 11a1 and the plurality of second antennas 11a2. Circles in FIG. 16 indicate the first antennas 11a1. Triangles indicate the plurality of second antennas 11a2. In the x-axis direction, 16 antennas 11T are arranged. In the y-axis direction, 16 antennas 11T are arranged. The element interval dx in the x-axis direction of the plurality of antennas 11T is 150 mm. The element interval dy in the y-axis direction of the plurality of antennas 11T is 150 mm. In this example, 256 antennas 11T are arranged with the same element interval in the x-axis direction and the y-axis direction.

The plurality of antennas 11T include the n-th antenna 11an. “n” is an integer not less than 1 and not more than 256. The coordinates of the n-th antenna 11an is defined as (x⁽ⁿ⁾, y⁽ⁿ⁾, z⁽ⁿ⁾). The beam direction of the n-th antenna 11an is defined as (θ, ϕ). The wave number of the n-th antenna 11an is defined as ko. The excitation phase K⁽ⁿ⁾ of the plurality of antennas 11T for controlling the beam direction is given by formula (22).

$${K}^{( n )} = - {k}_{0} ( {x}^{( n )} sin θ cos ϕ + {y}^{( n )} sin θsin ϕ + {z}^{( n )} cos θ ) \qquad ( 22 )$$

A linearly polarized wave is generated by combining the right-handed circularly polarized wave and the left-handed circularly polarized wave transmitted/received by the plurality of antennas 11T. The relative phase shift amount Δψ⁽ⁿ⁾ is given to the right-handed circularly polarized waves and the left-handed circularly polarized waves transmitted/received by the plurality of antennas 11T. From formula (1) and formula (2), formula (23) is obtained.

$${ϕ}_{R}^{( n )} = 2 {τ}^{( n )} + {ϕ}_{L}^{( n )} \qquad ( 23 )$$

From formulas (22) and (23), the phase of the right-handed circularly polarized wave (angle ϕ_{R}⁽ⁿ⁾) and the phase of the left-handed circularly polarized wave (angle ϕ_{L}⁽ⁿ⁾) transmitted/received by the n-th antenna 11an are given by formula (24) and formula (25), respectively.

$${ϕ}_{R}^{( n )} = 2 {τ}^{( n )} + {K}^{( n )} \qquad ( 24 )$$

$${ϕ}_{L}^{( n )} = {K}^{( n )} \qquad ( 25 )$$

The polarization angle τ⁽ⁿ⁾ of the linearly polarized waves transmitted/received by the plurality of antennas 11T may be different for each of the plurality of antennas 11T. Grating lobes occur when the polarization angle τ⁽ⁿ⁾ changes periodically.

In the example shown in FIGS. 16A and 16B, the polarization angle τ⁽ⁿ⁾ corresponding to the first antenna 11a1 indicated by circles is 0°. The polarization angle τ₍ₙ₎ corresponding to the second antenna 11a2 indicated by triangles is 11.25°. At this time, from formula (24), the relative phase difference between the right-handed circularly polarized wave transmitted/received by the first antenna 11a1 and the right-handed circularly polarized wave transmitted/received by the second antenna 11a2 is substantially equal to the minimum phase shift amount of 22.5° for a 4-bit phase shifter excluding K⁽ⁿ⁾.

In the example shown in FIG. 16A, the first antenna 11a1 and the second antenna 11a2 are arranged alternately in a direction parallel to the x-axis. In the example shown in FIG. 16A, similar to the example shown in FIG. 10, a grating lobe occurs in the radiation directivity in the direction parallel to the x-axis.

In the example shown in FIG. 16B, similar to the example shown in FIG. 12, the first antenna 11a1 and the second antenna 11a2 are not arranged alternately in the direction parallel to the x-axis. In the example shown in FIG. 16B, similar to the example shown in FIG. 12, grating lobes are suppressed in the radiation directivity in the direction parallel to the x-axis.

FIG. 17 shows the calculation results of the radiation directivity of the antenna device 320. In FIG. 17, the plurality of antennas 11T are omnidirectional antennas. In FIG. 17, the frequency is 1 GHZ. In FIG. 17, the beam directions (θ, ϕ) are (45°, 0°).

FIG. 17 shows the radiation directivity in a plane parallel to the x-axis. The solid line shown in FIG. 17 corresponds to the radiation directivity in the configuration shown in FIG. 16A. The dash-dot line shown in FIG. 17 corresponds to the radiation directivity in the configuration shown in FIG. 16B. The broken line shown in FIG. 17 corresponds to the radiation directivity when the polarization angle τ⁽ⁿ⁾ of the plurality of antennas 11T is 0°. In FIG. 17, the solid line characteristics are normalized by the maximum value in the solid line. The dash-dot line properties are normalized by the maximum value in the dash-dot line. The broken line properties are normalized by the maximum value on the broken line.

As shown in FIG. 17, in the configuration shown in FIG. 16A, a grating lobe is generated in the −15° direction in the radiation directivity in the direction parallel to the x-axis. On the other hand, in the configuration shown in FIG. 16B, the grating lobe in the −15° direction is suppressed in the radiation directivity in the direction parallel to the x-axis.

In the second embodiment, for example, the polarization angles of linearly polarized waves transmitted/received by the plurality of antennas 11T differ depending on the antennas 11T. At this time, the periodicity of the arrangement of the antennas 11T whose polarization angles of the linearly polarized waves to be transmitted/received are different from each other may be reduced. Thereby, grating lobes can be suppressed even when the beam direction is not 0°.

FIG. 18 is a schematic diagram illustrating an antenna device according to the second embodiment.

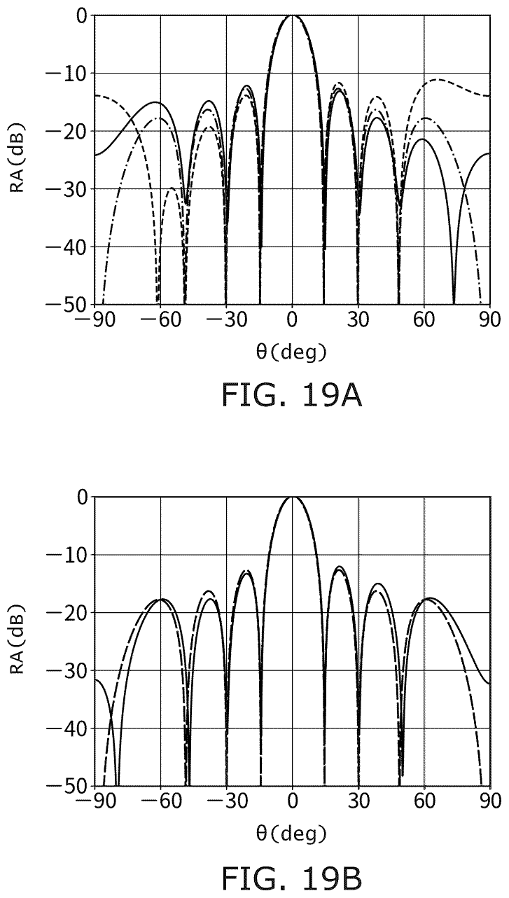

FIGS. 19A and 19B are graphs illustrating the characteristics of the antenna device according to the second embodiment.

In the embodiment, the polarization angles of the linearly polarized waves transmitted/received by the plurality of antennas 11T may differ depending on the antennas 11T. At this time, the plurality of antennas 11T having different polarization angles of linearly polarized waves to be transmitted/received may be randomly arranged.

A antenna device 300d illustrated in FIG. 18 may include the plurality of left phase shifters 12L, the plurality of right phase shifters 12R, the signal processing circuit 110, and the control circuit 115 (see FIG. 1) in addition to the plurality of antennas 11T.

As shown in FIG. 18, the antenna device 300d according to the embodiment includes 64 antennas 11T. The element interval of the plurality of antennas 11T may be the same as the element interval in the example shown in FIG. 10. For example, the relative phase shift amounts of the plurality of antennas 11T may be determined using pseudo-random numbers. For example, the 32 first antennas 11a1 transmit/receive radio waves with a phase shift of 0°. The 32 second antennas 11a2 transmit/receive radio waves with a phase of 22.5°.

In a case where the plurality of antennas 11T having different relative phase shifts are arranged at random, for example, “m” is obtained by the control circuit 115 (see FIG. 1) based on formula (10). Based on the obtained “m”, the relative phase shift amount of the radio waves transmitted/received by the plurality of antennas 11T is determined. For example, the control circuit 115 determines the relative phase shift amount of the radio waves transmitted/received by the plurality of antennas 11T so that the plurality of antennas 11T having different relative phase shift amounts are randomly arranged.

In the random arrangement, the plurality of antennas 11T having mutually different relative phase shifts of radio waves to be transmitted/received are randomly arranged. In the random arrangement, there is substantially no statistical regularity or statistical bias.

For example, “random numbers” may include pseudo-random numbers. The pseudorandom numbers are calculated based on, for example, a predetermined algorithm. The random numbers may be generated, for example, by at least one of a linear congruential method or a Mersenne twister.

For example, the relative phase shift amount of the radio waves transmitted/received by the n-th antenna 11an may be determined based on a sequence of N uniform random numbers. The N uniform random number sequence includes, for example, a value not less than 0 and not more than 1. For example, in a case where the n-th value of the generated uniform random number sequence is less than or equal to m/N, the polarization angle of the linearly polarized wave of the n-th antenna 11an is set to τ1. In a case where the n-th value of the generated uniform random number sequence is larger than m/N, the polarization angle of the linearly polarized wave of the n-th antenna 11an is set to τ2.

In the example shown in FIG. 18, τ⁽ⁿ⁾ is determined by the above method for the plurality of antennas 11T (the plurality of first antennas 11a1 and the plurality of second antennas 11a2).

For example, the relative phase shift amount of radio waves transmitted/received by the plurality of antennas 11T may be determined using random numbers each time “m” changes. For example, the control circuit 115 (see FIG. 1) may generate a random number sequence. The control circuit 115 may control the phase shift amount of the plurality of left phase shifters 12L and the phase shift amount of the plurality of right phase shifters 12R based on the generated random number sequence.

For example, a table (information) regarding “m” and the phase shift amount may be created. The table may be stored in the storage 18M (see FIG. 1), for example. The control circuit 115 may acquire information regarding “m” and the phase shift amount from the storage 18M. The control circuit 115 may control the phase shift amount of the plurality of left phase shifters 12L and the phase shift amount of the plurality of right phase shifters 12R based on the acquired information. For example, the tables may be created and stored in advance. For example, the amount of calculation in the control circuit 115 can be reduced.

The control circuit 115 controls the polarization angle of the linearly polarized waves transmitted/received by the plurality of antennas 11T by controlling the phase shift amount.

FIGS. 19A and 19B show examples of calculation results of radiation directivity characteristics of the antenna device 300d. In FIGS. 19A and 19B, the plurality of antennas 11T are omnidirectional antennas. In FIGS. 19A and 19B, the frequency is 1 GHz. In FIGS. 19A and 19B, the power transmitted/received by the plurality of antennas 11T is substantially equal. FIG. 19A shows the radiation directivity of the antenna device 300d in a plane parallel to the x-axis. FIG. 19B shows the radiation directivity of the antenna device 300d in a plane parallel to the y-axis. In FIGS. 19A and 19B, the solid lines correspond to the radiation directivity in the configuration shown in FIG. 18. In FIGS. 19A and 19B, the dash-dot line corresponds to the radiation directivity when the phase of radio waves transmitted/received by all antennas 11T is 0°. In FIGS. 19A and 19B, the broken line corresponds to the radiation directivity of the solid line shown in FIGS. 11A and 11B. That is, the broken line corresponds to the radiation directivity of the antenna device 300 shown in FIG. 10.

In FIG. 19B, the radiation directivity shown by the broken line is substantially consistent with the radiation directivity shown by the dash-dot line. In FIG. 19A, in the radiation directivity of antenna device 300d, grating lobes in the ±90° direction are suppressed compared to the radiation directivity of antenna device 300 shown in FIG. 10. Grating lobes can be suppressed by randomly arranging the plurality of antennas 11T having different relative phase shifts of radio waves to be transmitted/received.

FIGS. 19A and 19B show radiation directivity when the beam direction of the antenna device 300d is 0°. In the embodiment, grating lobes can be suppressed even when the beam direction of the antenna device 300d is not 0°.

In the embodiment, for example, when the polarization angles of the linearly polarized waves transmitted/received by the plurality of antennas 11T are different depending on the antennas 11T, the plurality of antennas 11T whose polarization angles of the linearly polarized waves transmitted/received are different from each other are randomly arranged. Thereby, grating lobes can be suppressed. Such a configuration may be applied when the antenna device according to the embodiment is used for at least one of transmitting or receiving.

The antenna device (for example, the antenna device 100) according to the embodiment may further include the control circuit 115 (see FIG. 1). The control circuit 115 may be configured to determine the polarization angle of the linearly polarized wave generated by another antenna 11T included in the plurality of antennas 11T based on the first polarization angle and the second polarization angle. The other antenna 11T is, for example, the n-th antenna 11an.

As shown in FIG. 1, the plurality of left phase shifters 12L further include other left phase shifters 12L. The other left phase shifter 12L is, for example, the n-th left phase shifter 12an. The other left phase shifter 12L is configured to discretely control the other left phase of the other left-handed circularly polarized signal generated by the other antenna 11T. The plurality of right phase shifters 12R further includes other right phase shifters 12R. The other right phase shifter 12R is, for example, the n-th right phase shifter 12bn. The other right phase shifter 12R is configured to discretely control the other right phase of the other right-handed circularly polarized signal generated by the other antenna 11T. For example, the control circuit 115 may be configured to control the other phase shift amount of the other left phase shifter 12L and the shift amount of the other right phase shifter 12R based on the polarization angle of the linearly polarized waves generated by the other antennas 11T and the transmission direction of the radio waves transmitted by the plurality of antennas 11T. The transmitting direction of the radio waves to be transmitted may be the transmitting/receiving direction. For example, at least one of the number of first antennas 11a1 or the number of second antennas 11a2 may be changed depending on the transmitting/receiving direction.

For example, in a first reference example, the plane of the polarization of linearly polarized waves to be transmitted/received is controlled by combining orthogonal linearly polarized waves. For example, in a second reference example, the plane of polarization of the linearly polarized waves transmitted/received by the antenna is controlled by controlling the amplitude difference and phase difference between the orthogonal linearly polarized waves. In a third reference example, the plane of polarization of linearly polarized waves to be transmitted/received is controlled by combining orthogonal circularly polarized waves. For example, by giving a phase difference to right-handed circularly polarized waves and left-handed circularly polarized waves, a circularly polarized antenna that generates linearly polarized waves can be obtained. For example, by giving a phase difference to right-handed circularly polarized waves and left-handed circularly polarized waves, a circularly polarized dual array antenna that generates linearly polarized waves can be obtained.

For example, in the technique of controlling the angle of the plane of polarization (angle of polarization) of linearly polarized waves transmitted/received by combining orthogonal linearly polarized waves, when rotating the plane of polarization, the amplitude of at least one of the orthogonal linearly polarized waves is reduced. Therefore, power loss occurs with polarization angle control.

On the other hand, in the technique of controlling the plane of polarization of linearly polarized waves to be transmitted/received by combining orthogonal circularly polarized waves, the plane of polarization can be rotated by controlling the phase difference between the orthogonal circularly polarized waves. The amplitude of circularly polarized waves to be transmitted/received is not reduced, and no power loss occurs due to polarization angle control.

However, if the phase shifter included in the antenna device is a digital phase shifter and the phase shift amount is discrete, the polarization angle of the linearly polarized wave transmitted/received by the antenna device is a discrete value depending on the minimum phase shift of the digital phase shifter. In this case, it becomes difficult to finely adjust the polarization angle. This results in power loss. Cross polarization discrimination is reduced. For example, reducing the minimum phase shift amount of a digital phase shifter increases cost.

In the embodiment, for example, the plane of polarization of the linearly polarized waves generated by the plurality of antennas 11T included in the antenna device is controlled for each antenna 11T. Thereby, the polarization angle of linearly polarized waves transmitted/received by the antenna device can be finely adjusted. For example, it is not necessary to increase the number of bits of the digital phase shifter used in the antenna device.

In the embodiment, for example, the plurality of antennas 11T combine right-handed circularly polarized waves and left-handed circularly polarized waves to generate linearly polarized waves. The polarization angle of linearly polarized waves generated for each of the plurality of antennas 11T is controlled. Thereby, the polarization angle of the linearly polarized wave, which is a combination of the linearly polarized waves transmitted by the plurality of antennas 11T, can be finely adjusted at fine intervals.

In the embodiment, the polarization angle of the linearly polarized wave of the first antenna 11a1 is τ1, and the polarization angle of the linearly polarized wave of the second antenna 11a2 is τ2. The power of the linearly polarized wave, which is a combination of the linearly polarized waves transmitted/received by the plurality of antennas 11T, becomes smaller as the difference between τ1 and τ2 becomes larger, and power loss occurs. By the difference between τ1 and τ2 being small, power loss is suppressed. For example, the polarization angle of the linearly polarized waves transmitted/received by the plurality of antennas 11T is an integer multiple of ½ of the first minimum phase shift amount. The difference between τ1 and τ2 is substantially minimum when it is ½ of the first minimum phase shift amount.

The embodiments may include a communication device 400 (see FIG. 1). The communication device 400 includes an antenna device (for example, antenna device 100) according to the embodiment and an electrical circuit 410. The electrical circuit 410 is configured to couple with an antenna device (e.g., antenna device 100). The electrical circuit 410 supplies signal 410s to antenna device 100. Radio waves corresponding to the signal 410s are transmitted from the antenna device 100. The electrical circuit 410 processes the signal 410s corresponding to the radio waves received by the antenna device 100. According to the embodiment, a wireless device with improved characteristics can be provided.

The embodiments may include the following Technical proposals:

### (Technical Proposal 1)

An antenna device, comprising:
a plurality of left phase shifters, the plurality of left phase shifters including a first left phase shifter and a second left phase shifter, the first left phase shifter being configured to discretely control a first left phase of a first left-handed circularly polarized signal, the second left phase shifter being configured to discretely control a first left phase of a second left-handed circularly polarized signal;
a plurality of right phase shifters, the plurality of right phase shifters including a first right phase shifter and a second right phase shifter, the first right phase shifter being configured to discretely control a first right phase of a first right-handed circularly polarized signal, the second right phase shifter being configured to discretely control a second right phase of a second right-handed circularly polarized signal; and
a plurality of antennas, the plurality of antennas including a first antenna and a second antenna, the first left phase shifter being configured to supply the first left-handed circularly polarized signal to the first antenna, the first right-handed phase shifter being configured to supply the first right-handed circularly polarized signal to the first antenna, the first antenna being configured to transmit a first left-handed circularly polarized wave based on the first left-handed circularly polarized signal and a first right-handed circularly polarized wave based on the first right-handed circularly polarized signal, the second left-handed phase shifter being configured to supply the second left-handed circularly polarized signal to the second antenna, the second right-handed phase shifter being configured to supply the second right-handed circularly polarized signal to the second antenna, the second antenna being configured to transmit a second left-handed circularly polarized wave based on the second left-handed circularly polarized signal and a second right-handed circularly polarized wave based on the second right-handed circularly polarized signal, a first polarization angle of a first linearly polarized wave generated by the first left-handed circularly polarized wave and the first right-handed circularly polarized wave being different from a second polarization angle of a second linearly polarized wave generated by the second left-handed circularly polarized wave and the second right-handed circularly polarized wave.
   (Technical proposal 2)

The antenna device according to Technical proposal 1, wherein
a first left phase shift amount of the first left phase shifter is a first integer multiple of a first minimum phase shift amount,
a first right phase shift amount of the first right phase shifter is a second integer multiple of the second minimum phase shift amount,
the first minimum phase shift amount is the same as the second minimum phase shift amount, and
an absolute value of a difference between the first polarization angle and the second polarization angle is not less than 0.45 times and not more than 0.55 times the first minimum phase shift amount.

### (Technical Proposal 3)

The antenna device according to Technical proposal 1, wherein
a first left phase shift amount of the first left phase shifter is a first integer multiple of a first minimum phase shift amount,
a first right phase shift amount of the first right phase shifter is a second integer multiple of a second minimum phase shift amount,
the first minimum phase shift amount is larger than the second minimum phase shift amount, and
a difference between the first polarization angle and the second polarization angle is 0.55 times or less of the first minimum phase shift amount.

### (Technical Proposal 4)

The antenna device according to any one of Technical proposals 1-3, further comprising:
a base, the plurality of antennas being provided on the base,
the base including a first partial region being continuous, and a second partial region being continuous,
the plurality of antennas including a plurality of the first antennas and a plurality of the second antennas,
the plurality of first antennas being provided in the first partial region and not provided in the second partial region, and
the plurality of second antennas being provided in the second partial region and not provided in the first partial region.

### (Technical Proposal 5)

The antenna device according to any one of Technical proposals 1-3, wherein
the plurality of antennas including a plurality of the first antennas and a plurality of the second antennas, and
the plurality of first antennas and the plurality of second antennas are provided randomly.

### (Technical Proposal 6)

The antenna device according to any one of Technical proposals 1-3, further comprising:
a control circuit,
the control circuit being configured to determine a polarization angle of a linearly polarized wave generated by another antenna included in the plurality of antennas based on the first polarization angle and the second polarization angle,
the plurality of left phase shifters further including another left phase shifter,
the other left phase shifter being configured to discretely control another left phase of another left-handed circularly polarized signal generated by the other antenna,
the plurality of right phase shifters further including another right phase shifter,
the other right phase shifter being configured to discretely control another right phase of another right-handed circularly polarized signal generated by the other antenna, and
the control circuit being configured to control another phase shift amount of the other left phase shifter and another phase shift amount of the other right phase shifter based on the polarization angle of the linearly polarized wave generated by the other antenna and a transmission direction of radio waves transmitted by the plurality of antennas.

### (Technical Proposal 7)

The antenna device according to Technical proposal 1, wherein
the plurality of antennas include a plurality of the first antennas, and
a number of the plurality of first antennas in a first state is different from a number of the plurality of first antennas in a second state.

### (Technical Proposal 8)

The antenna device according to any one of Technical proposals 1-7, further comprising:
a signal processing circuit combinable with the plurality of left phase shifters and the plurality of right phase shifters,
the signal processing circuit being configured to control at least one of an amplitude of the first left-handed circularly polarized signal, an amplitude of the second left-handed circularly polarized signal, an amplitude of the first right-handed circularly polarized signal, or an amplitude of the second right-handed circularly polarized signal

### (Technical Proposal 9)

The antenna device according to Technical proposal 8, wherein
the first polarization angle is controlled by controlling at least one of the amplitude of the first left-handed circularly polarized signal or the amplitude of the second left-handed circularly polarized signal, and
the second polarization angle is controlled by controlling at least one of the amplitude of the first right-handed circularly polarized signal or the amplitude of the second right-handed circularly polarized signal.

### (Technical Proposal 10)

A communication device, comprising:
the antenna device according to any one of Technical proposals 1-9; and
an electrical circuit configured to be coupled to the antenna device.

### (Technical Proposal 11)

An antenna device, comprising:
a plurality of antennas, the plurality of antennas including a first antenna and a second antenna, the first antenna being configured to receive a left-handed circularly polarized wave and a right-handed circularly polarized wave and to output a first left-handed circularly polarized wave signal and a first right-handed circularly polarized wave signal, the second antenna being configured to receive the left-handed circularly polarized wave and the right-handed circularly polarized wave and to output a second left-handed circularly polarized wave signal and a second right-handed circularly polarized wave signal;
a plurality of left phase shifters, the plurality of left phase shifters including a first left phase shifter and a second left phase shifter, the first left phase shifter being configured to discretely control a first left phase of the first left-handed circularly polarized signal, the second left phase shifter being configured to discretely control a second left phase of the second left-handed circularly polarized signal;
a plurality of right phase shifters, the plurality of right phase shifters including a first right phase shifter and a second right phase shifter, the first right phase shifter being configured to discretely control a first right phase of the first right-handed circularly polarized signal, the second right phase shifter being configured to discretely control a second right phase of the second right-handed circularly polarized signal; and
a signal processing circuit configured to be coupled to the plurality of left phase shifters and the plurality of right phase shifters, the signal processing circuit being configured to generate a linearly polarized signal indicating a linearly polarized wave from the first left-handed circularly polarized signal, the first right-handed circularly polarized signal, the second left-handed circularly polarized signal, and the second right-handed circularly polarized signal,
a first polarization angle of a first linearly polarized signal generated from the first left-handed circularly polarized signal and the first right-handed circularly polarized signal being different from a second polarization angle of a second linearly polarized signal generated from the second left-handed circularly polarized signal and the second right-handed circularly polarized signal,
a first left phase shift amount of the first left phase shifter, a second left phase shift amount of the second left phase shifter, a first right phase shift amount of the first right phase shifter, and a second right phase shift amount of the second right phase shifter being configured to satisfy at least one of a first condition or a second condition,
in the first condition, the first left phase shift amount being different from the second left phase shift amount, and
in the second condition, the first right phase shift amount being different from the second right phase shift amount.

### (Technical Proposal 12)

The antenna device according to Technical proposal 11, wherein
a difference between the first polarization angle and the second polarization angle is generated by changing at least one of the first left phase shift amount, the second left phase shift amount, the first right phase shift amount, or the second right phase shift amount.

### (Technical Proposal 13)

The antenna device according to Technical proposal 11 or 12, wherein
the first left phase shifter, the first right phase shifter, the second left phase shifter, and the second right phase shifter satisfy any one of a third condition and a fourth condition,
in the third condition, a relative first phase shift amount between the first left phase shifter and the first right phase shifter is controlled so that the linearly polarized signal is maximized when the first antenna receives the first linearly polarized wave having the first polarization angle, and a relative second phase shift amount between the second left phase shifter and the second right phase shifter is controlled so that the linearly polarized signal is maximized when the second antenna receives a second linearly polarized wave having the second polarization angle, and
in the fourth condition, the first phase shift amount is controlled so that the linearly polarized signal is minimized when the first antenna receives the first linearly polarized wave, and the second phase shift amount is controlled so that the linearly polarized signal is minimized when the second antenna receives the second linearly polarized wave.

### (Technical Proposal 14)

The antenna device according to Technical proposal 13, further comprising:
a control circuit,
the control circuit being configured to control at least one of the first phase shift amount or the second phase shift amount.

### (Technical Proposal 15)

The antenna device according to any one of Technical proposals 11-14, wherein
the first left phase shift amount is a first integer multiple of a first minimum phase shift amount,
the first right phase shift amount is a second integer multiple of a second minimum phase shift amount,
the first minimum phase shift amount is the same as the second minimum phase shift amount, and
an absolute value of a difference between the first polarization angle and the second polarization angle is not less than 0.45 times and not more than 0.55 times the first minimum phase shift amount.

### (Technical Proposal 16)

The antenna device according to any one of Technical proposals 11-14, wherein
the first left phase shift amount is a first integer multiple of a first minimum phase shift amount,
the first right phase shift amount is a second integer multiple of a second minimum phase shift amount,
the first minimum phase shift amount is larger than the second minimum phase shift amount, and
a difference between the first polarization angle and the second polarization angle is 0.55 times or less of the first minimum phase shift amount.

### (Technical Proposal 17)

The antenna device according to any one of Technical proposals 11-14, further comprising:
a base, the plurality of antennas being provided on the base,
the base including a first partial region being continuous and a second partial region being continuous,
the plurality of antennas including a plurality of the first antennas and a plurality of the second antennas,
the plurality of first antennas being provided in the first partial region and not provided in the second partial region, and
the plurality of second antennas being provided in the second partial region and not provided in the first partial region.

### (Technical Proposal 18)

The antenna device according to any one of Technical proposals 11-17, wherein
the plurality of antennas include a plurality of the first antennas and a plurality of the second antennas, and
the plurality of first antennas and the plurality of second antennas are randomly provided.

### (Technical Proposal 19)

The antenna device according to any one of Technical proposals 11-18, wherein
the plurality of antennas include a plurality of the first antennas, and
a number of the plurality of first antennas in a first state is different from a number of the plurality of first antennas in a second state.

### (Technical Proposal 20)

A communication device, comprising:
the antenna device according to any one of Technical proposals 11-19; and
an electrical circuit configured to be coupled to the antenna device.

According to the embodiment, it is possible to provide an antenna device and a communication device whose characteristics can be improved.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in antenna devices such as, antennas, phase shifters, signal processing circuits, control circuits, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all antenna devices and all communication devices practicable by an appropriate design modification by one skilled in the art based on the antenna devices and the communication devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An antenna device, comprising:
a plurality of left phase shifters, the plurality of left phase shifters including a first left phase shifter and a second left phase shifter, the first left phase shifter being configured to discretely control a first left phase of a first left-handed circularly polarized signal, the second left phase shifter being configured to discretely control a first left phase of a second left-handed circularly polarized signal;
a plurality of right phase shifters, the plurality of right phase shifters including a first right phase shifter and a second right phase shifter, the first right phase shifter being configured to discretely control a first right phase of a first right-handed circularly polarized signal, the second right phase shifter being configured to discretely control a second right phase of a second right-handed circularly polarized signal; and
a plurality of antennas, the plurality of antennas including a first antenna and a second antenna, the first left phase shifter being configured to supply the first left-handed circularly polarized signal to the first antenna, the first right-handed phase shifter being configured to supply the first right-handed circularly polarized signal to the first antenna, the first antenna being configured to transmit a first left-handed circularly polarized wave based on the first left-handed circularly polarized signal and a first right-handed circularly polarized wave based on the first right-handed circularly polarized signal, the second left-handed phase shifter being configured to supply the second left-handed circularly polarized signal to the second antenna, the second right-handed phase shifter being configured to supply the second right-handed circularly polarized signal to the second antenna, the second antenna being configured to transmit a second left-handed circularly polarized wave based on the second left-handed circularly polarized signal and a second right-handed circularly polarized wave based on the second right-handed circularly polarized signal,
a first polarization angle of a first linearly polarized wave generated by the first left-handed circularly polarized wave and the first right-handed circularly polarized wave being different from a second polarization angle of a second linearly polarized wave generated by the second left-handed circularly polarized wave and the second right-handed circularly polarized wave.

2. The antenna device according to claim 1, wherein
a first left phase shift amount of the first left phase shifter is a first integer multiple of a first minimum phase shift amount,
a first right phase shift amount of the first right phase shifter is a second integer multiple of the second minimum phase shift amount,
the first minimum phase shift amount is the same as the second minimum phase shift amount, and
an absolute value of a difference between the first polarization angle and the second polarization angle is not less than 0.45 times and not more than 0.55 times the first minimum phase shift amount.

3. The antenna device according to claim 1, wherein
a first left phase shift amount of the first left phase shifter is a first integer multiple of a first minimum phase shift amount,
a first right phase shift amount of the first right phase shifter is a second integer multiple of a second minimum phase shift amount,
the first minimum phase shift amount is larger than the second minimum phase shift amount, and
a difference between the first polarization angle and the second polarization angle is 0.55 times or less of the first minimum phase shift amount.

4. The antenna device according to claim 1, further comprising:
a base, the plurality of antennas being provided on the base,
the base including a first partial region being continuous, and a second partial region being continuous,
the plurality of antennas including a plurality of the first antennas and a plurality of the second antennas,
the plurality of first antennas being provided in the first partial region and not provided in the second partial region, and
the plurality of second antennas being provided in the second partial region and not provided in the first partial region.

5. The antenna device according to claim 1, wherein
the plurality of antennas including a plurality of the first antennas and a plurality of the second antennas, and
the plurality of first antennas and the plurality of second antennas are provided randomly.

6. The antenna device according to claim 1, further comprising:
a control circuit,
the control circuit being configured to determine a polarization angle of a linearly polarized wave generated by another antenna included in the plurality of antennas based on the first polarization angle and the second polarization angle,
the plurality of left phase shifters further including another left phase shifter,
the other left phase shifter being configured to discretely control another left phase of another left-handed circularly polarized signal generated by the other antenna,
the plurality of right phase shifters further including another right phase shifter,
the other right phase shifter being configured to discretely control another right phase of another right-handed circularly polarized signal generated by the other antenna, and
the control circuit being configured to control another phase shift amount of the other left phase shifter and another phase shift amount of the other right phase shifter based on the polarization angle of the linearly polarized wave generated by the other antenna and a transmission direction of radio waves transmitted by the plurality of antennas.

7. The antenna device according to claim 1, wherein
the plurality of antennas include a plurality of the first antennas, and
a number of the plurality of first antennas in a first state is different from a number of the plurality of first antennas in a second state.

8. The antenna device according to claim 1, further comprising:
a signal processing circuit combinable with the plurality of left phase shifters and the plurality of right phase shifters,
the signal processing circuit being configured to control at least one of an amplitude of the first left-handed circularly polarized signal, an amplitude of the second left-handed circularly polarized signal, an amplitude of the first right-handed circularly polarized signal, or an amplitude of the second right-handed circularly polarized signal.

9. The antenna device according to claim 8, wherein
the first polarization angle is controlled by controlling at least one of the amplitude of the first left-handed circularly polarized signal or the amplitude of the second left-handed circularly polarized signal, and
the second polarization angle is controlled by controlling at least one of the amplitude of the first right-handed circularly polarized signal or the amplitude of the second right-handed circularly polarized signal.

10. A communication device, comprising:
the antenna device according to claim 1; and
an electrical circuit configured to be coupled to the antenna device.

11. An antenna device, comprising:
a plurality of antennas, the plurality of antennas including a first antenna and a second antenna, the first antenna being configured to receive a left-handed circularly polarized wave and a right-handed circularly polarized wave and to output a first left-handed circularly polarized wave signal and a first right-handed circularly polarized wave signal, the second antenna being configured to receive the left-handed circularly polarized wave and the right-handed circularly polarized wave and to output a second left-handed circularly polarized wave signal and a second right-handed circularly polarized wave signal;
a plurality of left phase shifters, the plurality of left phase shifters including a first left phase shifter and a second left phase shifter, the first left phase shifter being configured to discretely control a first left phase of the first left-handed circularly polarized signal, the second left phase shifter being configured to discretely control a second left phase of the second left-handed circularly polarized signal;
a plurality of right phase shifters, the plurality of right phase shifters including a first right phase shifter and a second right phase shifter, the first right phase shifter being configured to discretely control a first right phase of the first right-handed circularly polarized signal, the second right phase shifter being configured to discretely control a second right phase of the second right-handed circularly polarized signal; and
a signal processing circuit configured to be coupled to the plurality of left phase shifters and the plurality of right phase shifters, the signal processing circuit being configured to generate a linearly polarized signal indicating a linearly polarized wave from the first left-handed circularly polarized signal, the first right-handed circularly polarized signal, the second left-handed circularly polarized signal, and the second right-handed circularly polarized signal,
a first polarization angle of a first linearly polarized signal generated from the first left-handed circularly polarized signal and the first right-handed circularly polarized signal being different from a second polarization angle of a second linearly polarized signal generated from the second left-handed circularly polarized signal and the second right-handed circularly polarized signal,
a first left phase shift amount of the first left phase shifter, a second left phase shift amount of the second left phase shifter, a first right phase shift amount of the first right phase shifter, and a second right phase shift amount of the second right phase shifter being configured to satisfy at least one of a first condition or a second condition,
in the first condition, the first left phase shift amount being different from the second left phase shift amount, and
in the second condition, the first right phase shift amount being different from the second right phase shift amount.

12. The antenna device according to claim 11, wherein
a difference between the first polarization angle and the second polarization angle is generated by changing at least one of the first left phase shift amount, the second left phase shift amount, the first right phase shift amount, or the second right phase shift amount.

13. The antenna device according to claim 11, wherein
the first left phase shifter, the first right phase shifter, the second left phase shifter, and the second right phase shifter satisfy any one of a third condition and a fourth condition,
in the third condition, a relative first phase shift amount between the first left phase shifter and the first right phase shifter is controlled so that the linearly polarized signal is maximized when the first antenna receives the first linearly polarized wave having the first polarization angle, and a relative second phase shift amount between the second left phase shifter and the second right phase shifter is controlled so that the linearly polarized signal is maximized when the second antenna receives a second linearly polarized wave having the second polarization angle, and
in the fourth condition, the first phase shift amount is controlled so that the linearly polarized signal is minimized when the first antenna receives the first linearly polarized wave, and the second phase shift amount is controlled so that the linearly polarized signal is minimized when the second antenna receives the second linearly polarized wave.

14. The antenna device according to claim 13, further comprising:
a control circuit,
the control circuit being configured to control at least one of the first phase shift amount or the second phase shift amount.

15. The antenna device according to claim 11, wherein
the first left phase shift amount is a first integer multiple of a first minimum phase shift amount,
the first right phase shift amount is a second integer multiple of a second minimum phase shift amount,
the first minimum phase shift amount is the same as the second minimum phase shift amount, and
an absolute value of a difference between the first polarization angle and the second polarization angle is not less than 0.45 times and not more than 0.55 times the first minimum phase shift amount.

16. The antenna device according to claim 11, wherein
the first left phase shift amount is a first integer multiple of a first minimum phase shift amount,
the first right phase shift amount is a second integer multiple of a second minimum phase shift amount,
the first minimum phase shift amount is larger than the second minimum phase shift amount, and
a difference between the first polarization angle and the second polarization angle is 0.55 times or less of the first minimum phase shift amount.

17. The antenna device according to claim 11, further comprising:
a base, the plurality of antennas being provided on the base,
the base including a first partial region being continuous and a second partial region being continuous,
the plurality of antennas including a plurality of the first antennas and a plurality of the second antennas,
the plurality of first antennas being provided in the first partial region and not provided in the second partial region, and
the plurality of second antennas being provided in the second partial region and not provided in the first partial region.

18. The antenna device according to claim 11, wherein
the plurality of antennas include a plurality of the first antennas and a plurality of the second antennas, and
the plurality of first antennas and the plurality of second antennas are randomly provided.

19. The antenna device according to claim 11, wherein
the plurality of antennas include a plurality of the first antennas, and
a number of the plurality of first antennas in a first state is different from a number of the plurality of first antennas in a second state.

20. A communication device, comprising:
the antenna device according to claim 11; and
an electrical circuit configured to be coupled to the antenna device.
